(19) United States
(12) Patent Application Publication
(10) Pub. No.: US 2013/0063299 A1
(43) Pub. Date: Mar. 14, 2013

(54) Systems, Methods and Apparatuses for Remote Device Detection

(71) Applicant: Vassili P. Proudkii, Edmonton (CA)

(72) Inventor: Vassili P. Proudkii, Edmonton (CA)

(73) Assignees: Cavitid Inc., Alberta, CA (US); Sky Holdings Company LLC, Warrenton, VA (US)

(21) Appl. No.: 13/579,216

(22) PCT Filed: Feb. 15, 2011
(86) PCT No.: PCT/US11/24836

§ 371 Date: Nov. 27, 2012

Related U.S. Application Data
(60) Provisional application No. 61/344,822, filed on Oct. 18, 2010.
(60) Provisional application No. 61/282,462, filed on Feb. 16, 2010.

(51) Int. Cl. G01S 13/00

(52) U.S. Cl. 342/188

(57) ABSTRACT

A radar device has a transmitter having a field of view for transmitting a transmit signal and a receiver for receiving a received signal from the field of view of the transmitter. The transmit signal comprising first and second polarization components and multiple frequencies. There is a signal processor programmed to: detect received signal components comprising first and second polarization components and fundamental and harmonic frequencies corresponding to the first and second polarization components and multiple frequencies in the received signal; compare the received signal components to characterize the received signal and identify a remote device as a linear conductor or a non-linear conductor based on predetermined criteria; and generate a notification signal corresponding to the remote device when the remote device is identified.

### CROSS REFERENCE TO RELATED APPLICATIONS

This application claims the benefit of priority from U.S. Provisional Application No. 61/282,462, filed on Feb. 16, 2010, and U.S. Provisional Application No. 61/344,822, filed Oct. 18, 2010. The foregoing related applications, in their entirety, are incorporated herein by reference.

### FIELD OF THE DISCLOSURE

This relates to a system design for a radar device for detecting conductive wires and/or non-linear conductors, and that may be used to determine the presence and location of a command wire or wireless receiver used to remotely detonate an improvised explosive device (IED).

### BACKGROUND OF THE DISCLOSURE

Improvised explosive devices (IEDs) are often deployed by terrorist or paramilitary groups. As they are “improvised”, they are not built to any set standard, which makes detection difficult. While IEDs must be assumed to be unique, there is a commonality in that they each have an explosive element, a detonator device, and a control for the detonator device. The IED can be defeated if any of these elements can be detected and disabled.

### SUMMARY OF THE DISCLOSURE

Certain embodiments relate to a radar device for detecting improvised explosive device triggers, comprising a transmitter with frequency adjustability and power adjustability for transmitting electromagnetic signals with a first and second polarization, a tuneable receiver for receiving a reflection of the electromagnetic signal transmitted by the transmitter and at least one harmonic frequency thereof, and an actively controlled cancellation circuit (e.g., a nulling circuit) comprising a signal path between the transmitter and the receiver for each of the first polarization and the second polarization of the electromagnetic signal and the at least one harmonic frequency thereof. Each signal path having a directional coupler and a reflective load coupled to a terminal of the directional coupler. In certain embodiments, each signal path may consist essentially of or consist only of a directional coupler and a reflective load coupled to a terminal of the directional coupler. The device further comprises a processor configured to compare at least one output of the actively controlled cancellation circuit to at least one of a previously received output of the actively controlled cancellation circuit and/or a predetermined reference to identify the presence of a conductive wire and/or a non-linear junction within a field of view of the device.

Certain embodiments relate to a device comprising at least one transmitter with frequency adjustability and power adjustability configured to transmit an electromagnetic signal with a first and second polarization at a plurality of frequencies and a command wire detection circuit configured to detect a command wire of an improvised explosive device, comprising a tuneable receiver. The tuneable receiver comprises a first actively controlled cancellation circuit configured to receive the reflection of the first polarization of the electromagnetic signal and a second actively controlled cancellation circuit configured to receive the reflection of the second polarization of the electromagnetic signal. The device also comprises a non-linear junction detection circuit configured to detect a non-linear junction within the improvised explosive device, comprising a tuneable receiver comprising a third actively controlled cancellation circuit configured to receive the at least one harmonic of at least a portion of the electromagnetic signal. The device also comprises a processor configured to compare the at least one output of the command wire detection circuit and/or the non-linear junction detection circuit with a predetermined reference and/or with previously received circuit outputs to generate an indication based on the current and previously received circuit outputs that can be used to locate the command wire and/or non-linear junction. In certain embodiments, each actively controlled cancellation circuit comprises a reflective load. In certain embodiments the actively controlled cancellation circuit has a rejection level of greater than 50 dB. In certain embodiments, the adjustable transmitter is configured to sweep across at least 10 frequencies.

Certain embodiments relate to a radar device for detecting improvised explosive device triggers, comprising a transmitter with frequency adjustability and power adjustability configured to transmit an electromagnetic signal with a first and second polarization at a plurality of frequencies, a tuneable receiver configured to receive a reflection of the fundamental frequency and at least one harmonic frequency of the transmitted signal, an actively controlled cancellation circuit for at least each of (i) the first polarization of a fundamental frequency, (ii) the second polarization of a fundamental frequency, and (iii) the at least one harmonic frequency, each actively controlled cancellation circuit generating a predefined cancellation signal for cancelling undesired signal components, and a processor configured to use the output of the actively controlled cancellation circuit to identify a command wire connected to an improvised explosive device or a wireless receiver connected to an improvised explosive device.

Certain embodiments relate to a radar device for detecting improvised explosive trigger devices, comprising a transmitter with frequency adjustability and power adjustability configured to transmit an electromagnetic signal with a first and second polarization at a plurality of frequencies, a tuneable receiver configured to receive a reflection of the fundamental frequency and at least one harmonic frequency of each transmitted signal and an actively controlled cancellation circuit comprising a signal path between the adjustable transmitter and the receiver for each of (i) a fundamental frequency with a first polarization, (ii) a fundamental frequency with a second polarization, and (iii) the at least one harmonic frequency. Each signal path consists essentially of two directional couplers; and an attenuator and phase shifter coupled between a terminal of the first directional coupler and second directional coupler. The device further comprises a processor configured to compare a predetermined calibration to the received signal and to compare the received signal to previously received signals to characterize the received signal and identify a conductive wire or a non-linear junction.

Certain embodiments relate to a device for identifying and destroying devices containing non-linear junctions, the device comprising at least one transmitter with frequency adjustability and power adjustability configured to transmit an electromagnetic signal with a first and second polarization at a plurality of frequencies, a non-linear junction detection circuit configured to detect a non-linear junction within the improvised explosive device, comprising a receiver. The receiver comprises an actively controlled cancellation circuit configured to receive the at least one harmonic of the electromagnetic signal. The device also comprises a processor configured to compare the at least one output of the non-linear junction detection circuit with a predetermined reference and/or with previously received electromagnetic signals to generate an indication based on the current and previously received electromagnetic signals that can be used to locate the non-linear junction. Additionally, the device comprises a power amplifier coupled to the transmitter to amplify a pulse of a predetermined duration to a significantly increased level to destroy the identified non-linear junction. In certain embodiments, each actively controlled cancellation circuit comprises a reflective load or non-reflective load. In certain embodiments the actively controlled cancellation circuit has a rejection level of greater than 50 dB. In certain embodiments, the adjustable transmitter is configured to sweep across at least 10 frequencies.

In certain embodiments, the device is a continuous wave device.

In certain embodiments, the reflective load comprises an attenuator and phase shifter controlled by the processor.

In certain embodiments, the processor is configured to control the phase shifter and the attenuator by outputting a highly stable control signal that is substantially monotonic relative to a desired control input.

In certain embodiments, at least one of a visual indicator, graphical display, or scatterplot to indicate the presence of the command wire or the non-linear junction.

In certain embodiments, the actively controlled cancellation circuit has a rejection level of greater than 50 dB (i.e., greater than 50 dB, 60 dB, 70 dB, 80 dB, 90 dB, 100 dB, 110 dB, 120 dB, 130 dB, 140 dB, 145 dB, 150 dB, 155 dB, 160 dB).

In certain embodiments, the device is configured to sweep across at least one octave.

In certain embodiments, the device is configured to sweep across at least 50 (i.e., at least 75, 100, 125, 150, 175, 200, 225, 250) frequencies.

In certain embodiments, the device further comprises a circuit capable of disabling non linear junctions; and a processor capable of a coarse frequency scanning mode and a fine frequency scanning mode.

In certain embodiments, the adjustable transmitter generates a stable signal with a narrow bandwidth.

In certain embodiments, the adjustable transmitter comprises a rubidium oscillator and the receiver is configured to receive a narrow bandwidth signal.

In certain embodiments, the adjustable transmitter comprises an ovenized crystal oscillator and the receiver is configured to receive a narrow bandwidth signal.

In certain embodiments, the receiver may be configured to limit the bandwidth of the received signal to less than 20 Hz (i.e., less than 18 Hz, 15 Hz, 12 Hz, 10 Hz, 7 Hz, 5 Hz) centered around a transmit frequency.

In certain embodiments, the processor is configured to develop a predetermined reference based on received signals reflected off the background and identifies differences in the received signal relative to the background.

In certain embodiments, at least one of the transmitter and the receiver comprises a first antenna for the first polarization and a second antenna for the second polarization.

In certain embodiments, the device further comprises a single antenna that transmits at least one signal component from the transmitter and receives a corresponding reflected signal component into the receiver.

In certain embodiments, the transmitted electromagnetic signal is a radio frequency signal.

In certain embodiments, the plurality of frequencies are transmitted serially.

In certain embodiments, the plurality of frequencies are transmitted simultaneously.

In certain embodiments, the transmitter comprises multiple transmit antennas, each having the same field of view.

In certain embodiments, the processor is programmed to focus the field of view of the received signal using beam forming.

In certain embodiments, the first polarization is orthogonal to the second polarization.

Certain embodiments relate to a method of using the devices described herein comprising scanning a target area in the coarse scanning mode until an indication that a non-linear junction is present is received at a first frequency, scanning the target area in a fine scanning mode until an indication that a non-linear junction is present is received at a second frequency setting the transmitter to the second frequency, transmitting a power pulse of a predetermined duration at a significantly increased level to destroy the identified device, and confirming that the identified device has been destroyed by transmitting a signal at the second frequency and observing the that substantially no non linear junction response in the harmonics is generated.

Certain embodiments relate to a method for confirming the destruction and/or disabling of a device containing a non-linear junction, the method comprising utilizing a coarse frequency scanning mode to scan a target area, scanning a plurality of frequencies in the coarse scanning mode to identify a first frequency that generates the largest non linear junction response in the harmonics, switching to a fine frequency scanning mode to scan at least a portion of the target area, scanning a plurality of frequencies to more precisely identify a second frequency that generates the largest non linear junction response in the harmonics, setting the transmitter to the second frequency, transmitting a power pulse of a predetermined duration and comprising sufficient energy to disable at least a portion of the identified device, and confirming that the identified device has been destroyed by transmitting a signal at the second frequency and observing that substantially no non linear junction response in the harmonics is generated.

In certain embodiments, the plurality of frequencies are generated by a transmitter with frequency adjustability and power adjustability configured to transmit an electromagnetic signal with a first and second polarization at a plurality of frequencies

In certain embodiments, the identification of the first and second frequencies is achieved using a tuneable receiver configured to receive a reflection of the fundamental frequency and at least one harmonic frequency of the transmitted signal; an actively controlled cancellation circuit for at least each of (i) the first polarization of a fundamental frequency, (ii) the second polarization of a fundamental frequency, and (iii) the at least one harmonic frequency, each actively controlled cancellation circuit generating a predefined cancellation signal for cancelling undesired signal components; and a processor configured to use the output of the actively controlled cancellation circuit to identify a command wire connected to an improvised explosive device or a wireless receiver connected to an improvised explosive device.

In certain embodiments, there is provided a radar device, comprising a transmitter that transmits a transmit signal, such as a radio frequency signal, and a receiver for receiving a received signal from the field of view of the transmit antenna. The transmit signal is an electromagnetic signal and has first and second polarizations and multiple frequencies. There is a signal processor that is programmed to: detect received signal components comprising first and second polarizations and fundamental and harmonic frequencies corresponding to the first and second polarization and multiple frequencies in the received signal; compare the received signal components to characterize the received signal and identify a remote device as either a linear electrical component or a non-linear electrical component based on predetermined criteria; and generate a notification signal corresponding to the remote device when the remote device is identified.

In certain embodiments, the radar device may be a handheld device.

In certain embodiments, the device may have a rejection level of greater than 90 dB. For example, the device may have a rejection level of about 90-100 dB, 100-120 dB, 110-130 dB, 130-150 dB, 145-155 dB, about 140 dB, about 145 dB, about 150 dB, about 155 dB.

In certain embodiments, the signal processor may form a background image of the field of view from the received signal and the predetermined criteria may comprise differences in the received signal relative to the background image. The predetermined criteria may comprises criteria from previously detected and compared signals.

In certain embodiments, at least one of the transmitter and the receiver may comprise a first antenna for the first polarization and a second antenna for the second polarization. A single antenna may be used to transmit at least one signal component from the transmitter and to receive a corresponding signal component into the receiver. The transmit signal antenna may transmit multiple frequencies serially or simultaneously. There may be multiple transmit antennas having the same field of view. The processor may be programmed to focus the field of view of the received signal using beam forming.

In certain embodiments, a received fundamental frequency may characterize the remote device as a linear electrical component and a received harmonic frequency may characterize the remote device as a non-linear electrical component. The remote device may further be identified based on at least one of size, location, shape, and position relative to ground surface.

In certain embodiments, the first polarization may have a component that is orthogonal to the second polarization.

In certain embodiments, the radar device may further comprise an actively controlled cancellation circuit for controlling signal leakage from the transmitter to the receiver. The signal cancellation circuit may comprise a signal path between the transmitter and the receiver for each of a fundamental frequency and at least one harmonic frequency, each signal path comprising a controllable phase shift block and a controllable gain shift block controlled by the processor to reduce the signal leakage component in the receiver.

In certain embodiments, there is provided a method of detecting buried conductors (e.g., command wires), comprising the steps of: transmitting a signal from a transmitter having a field of view, the transmit signal comprising an electromagnetic signal, such as a radio frequency signal, having first and second polarizations and multiple frequencies; receiving a signal from the field of view by a receiver; detecting first and second polarization components and fundamental and harmonic frequencies corresponding to the first and second polarization components and multiple frequencies in the received signal; comparing the received signal components to characterize the received signal and identify a remote device as a linear electrical component or a non-linear electrical component based on predetermined criteria; and generating a notification signal when the remote device is identified.

In certain embodiments, comparing the received signal components may comprise forming a background image of the field of view from the received signal and identifying differences in the received signal relative to the background image.

In certain embodiments, at least one of the transmitter and the receiver may comprise a first antenna for the first polarization component and a second antenna for the second polarization component. The transmit signal may be transmitted and the received signal may be received by a single antenna. The transmit antenna may transmit multiple frequencies serially or in parallel. The transmit signal may be transmitted from multiple transmit antennas having the same field of view. The received signal may be received from multiple receive antennas having the same field of view. The field of view may be shifted, and a common signal in multiple fields of view may identify the remote device as a moving device. Beam forming may be used to focus the field of view of the received signal.

In certain embodiments, a received fundamental frequency may identify the remote device as a linear electrical component and a received fundamental frequency may identify the remote device as a non-linear electrical component. The remote device may further be identified based on at least one of size, location, shape, and position relative to ground surface.

In certain embodiments, the method may comprise the step of controlling signal leakage from the transmitter to the receiver using an actively controlled cancellation circuit. The signal cancellation circuit may comprise a signal path between the transmitter and the receiver for each of a fundamental frequency and at least one harmonic frequency, each signal path comprising a controllable phase shift block and a controllable gain shift block controlled by the processor to reduce the signal leakage component on the receiver.

According to another aspect, there is provided a radar device for detecting improvised explosive devices (IEDs), comprising a transmitter having a field of view that transmits a transmit signal, and a receiver that receives a received signal from the field of view of the transmitter. The transmit signal comprising an electromagnetic signal having signal components comprising first and second polarizations and multiple frequencies. There is an actively controlled cancellation circuit that comprises a signal path between the transmitter and the receiver for each of a fundamental frequency and at least one harmonic frequency, each signal path comprising a controllable phase shift block and a controllable gain shift block controlled by the processor to reduce a signal leakage component induced in the receiver by the transmitter. There is a processor programmed to: control the phase shift block and the controllable gain shift block in the actively controlled cancellation circuit to reduce the signal leakage component; detect received signal components comprising first and second polarizations and fundamental and harmonic frequencies corresponding to the first and second polarizations and multiple frequencies in the received signal; compare the received signal components to characterize the received signal and identify a remote device as a command wire connected to an IED or a wireless receiver connected to an IED based on predetermined criteria; and generate a notification signal corresponding to the remote device when the remote device is identified.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic depiction of an embodiment of a radar device in use.

FIG. 2 is a bock diagram of an embodiment of circuitry of an embodiment of a radar device for detecting a linear conductor (e.g., command wire).

FIG. 3 is a block diagram of an embodiment of adjustable scaling and delay circuit block used to null out undesired signal return.

FIG. 4 is a block diagram of an embodiment of suppression circuits for two polarizations.

FIG. 5 is a block diagram of an embodiment of a radar used to detect a wire conductor.

FIG. 6 is a graph of an estimated radiation pattern on the ground.

FIG. 7 is a graph of an estimated radiation pattern in terms of angle.

FIG. 8 is a graph of an estimated radiation power incident on the ground.

FIG. 9 is a graph of relative clutter backscatter power as a function of the range.

FIG. 10 is a graph of backscatter and wire target with Fourier beam processing.

FIG. 11 is a block diagram of an embodiment of circuitry of a radar device for detecting a non-linear junction.

FIG. 12 is a block diagram of an embodiment of a synchronous receiver for receiving harmonic components of a transmitted and received signal.

FIG. 13 is a graph of a power level of second and third harmonics reflected from a non-linear conductor.

FIG. 14 is an embodiment of a scanning stable frequency circuit in conjunction with a nulling circuit.

FIG. 15 is an embodiment of a four port directional coupler.

FIG. 16 is an embodiment of a four port directional coupler with a reflective load.

FIG. 17 is an embodiment of a reflective load comprising a phase shifter and attenuator in series.

FIG. 18 is an embodiment of a four port directional coupler including a connection to a transmitter, antenna and receiver with a reflective load.

FIG. 19 is a method of achieving a high resolution control voltage.

FIG. 20 is an embodiment of a method of achieving a nanovolt generator for control over a broad range that is substantially monotonic.

FIG. 21 is an embodiment of a coarse digital-to-analog converter providing an offset bias voltage to a nanovolt controller.

FIG. 22 is an embodiment of a destruction and/or disabling circuit in conjunction with a nulling circuit for the detection and destruction and/or disabling of non-linear junctions.

FIG. 23 is another embodiment of a destruction and/or disabling circuit in conjunction with a nulling circuit for the detection and destruction and/or disabling of non-linear junctions.

### DETAILED DESCRIPTION OF EMBODIMENTS

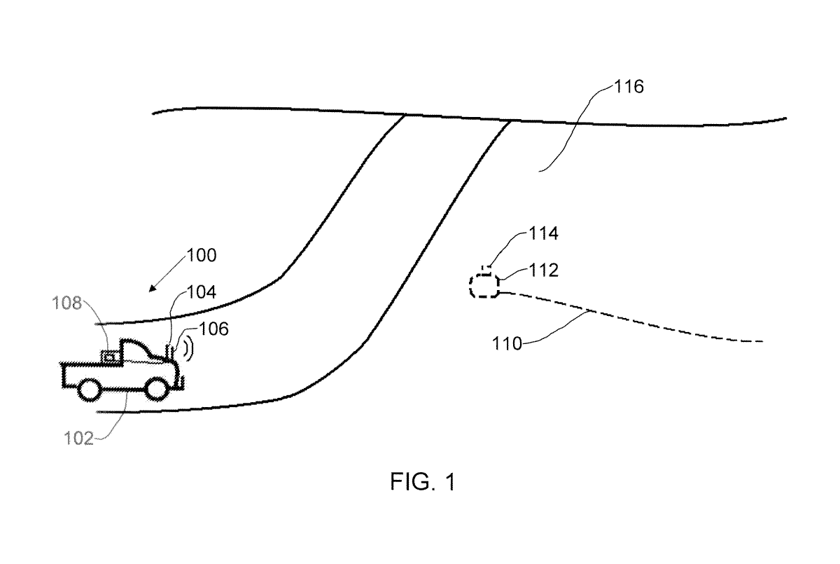

The system and method described herein can be applied to a generic improvised explosive deceive (IED) detector that is able to detect the presence of a command wire or a receiver for a wireless link. A brief overview of the device and the method of operation in an embodiment will first be given with reference to FIG. 1, after which a more detailed description will be given.

The discussion below relates specifically to the detection of IEDs. However, it will be understood that the applications go beyond this situation, and can be applied to other situations where radar detection may be useful, such as the remote detection of other types of linear and/or non-linear components. Any modifications necessary to allow the device to be used for other applications will be apparent to those skilled in the art once the principles discussed herein are understood. As used herein, the term “non-linear component” or “non-linear electrical component” refers to a two port electrical component that does not produce a proportional change in the output of one port for a given change in the other port. This may be contrasted with the term “linear component” or “linear electrical component” that does produce a proportional change. For the purposes of the discussion herein, it will be understood that the term “components” also extends to devices, systems, sub-systems, etc. that result in a linear or non-linear response.

1. Overview

Referring to FIG. 1, the IED detector 100 is fundamentally a radar that operates with a set of discrete RF frequencies over the range of several hundred MHz to several GHz. This is preferably a self contained portable unit that can be mounted on an airborne platform, may be carried by personnel, or, as shown, may be mounted on a land vehicle 102. In other embodiments, detector 100 may be part of a fixed installation. The IED detector has a transmit antenna 104, a receive antenna 106, and circuitry 108 for generating transmit signals and analyzing return echo signals. It will be understood that this is for illustration purposes only, and that variations on the design are expected. For example, the circuitry 108 is made up of various components, which may be combined in one or more integrated circuit package, or may be distinct, such as a detection component, and a processor component. Furthermore, with respect to the antennas, there may be a single antenna that transmits and receives, or there may be two or more antennas configured in different ways. Generally, the transmitted signal will include multiple components, such as different polarizations, and different frequencies. These different components may be transmitted simultaneously or sequentially. The antennas used may be designed for specific signal components, such as an antenna for different polarizations. In addition, there may be multiple antennas focused on one field of view to obtain samples from different locations, or multiple antennas focused on different fields of view, which may overlap, to increase the overall detection area or to detect movement of a remote device.

Most IEDs are triggered by either a command wire (CDW) or a wireless connection, which requires a non-linear junction (NLJ) on the IED. Generally speaking, the CDW is linear and will reflect a fundamental frequency, while the NLJ is non-linear and will reflect a harmonic frequency. Accordingly, in the discussion herein, a reference to either CDW or NLJ may be generalized to other linear or non-linear components aside from those in IEDs. Similarly, the discussion relating to the field of view, signal generation and detection, signal leakage cancellation, etc. may also be generalized beyond IED detection.

The radar 100 transmits a set of M frequencies, such as in step sequence, where M is typically in the range of 50 to several hundred (e.g., greater than 5, greater than 10, greater than 15, greater than 20, greater than 25, greater than 30, greater than 35, greater than 40, greater than 45, greater than 50, greater than 60, greater than 70, greater than 80, greater than 90, greater than 100, greater than 125, greater than 150, greater than 200, greater than 250, greater than 300, greater than 400, greater than 500). Since the duration of each frequency transmission is preferably longer than the round trip return time of the IED radar, it may be considered herein as a CW (continuous wave) radar. As the frequency is also preferably transmitted in steps, it may also be considered a step frequency radar. Other versions may use a continuous frequency sweeping in a specified range, or multiple frequency transmissions simultaneously. The desired signal component of the radar echo is the fundamental frequency, which results from a CDW 110 connected to an IED 112 or the harmonics of the fundamental, which results from the electronic components of a wireless receiver 114. While both the CDW 110 and the wireless receiver 114 are shown with the IED 112, this is done for illustration purposes only, and it will be understood that in some cases only one type of command link may be present. The electronic components in the wireless receiver 114 will be mildly nonlinear as they are based on semiconductor junction devices. Devices that originate harmonics of the fundamental frequency of the RF stimulus signal will be referred to as Nils. Generally speaking the IED 112 and its CDW 110 or NLJ 114 will be buried under the ground surface 116.

As it is unknown what type of control link may be encountered, the radar 100 is designed to be sensitive to the both fundamental and harmonic components contained in the feeble echo from the IED device 112, should it be present. The radar combines all of the data from the multitude of observations involving the set of discrete frequencies, antenna polarizations and different spatial positions of the antenna 104/106. In this way it can build up the desired signal from the CDW and NLJ and further suppress the interference and noise sources.

To better understand the methods of detection, consider a generic detection case based on the following steps. First some notation is necessary. The set of transmission frequencies is defined by a start frequency of f₁ and an end frequency f_{M} with a uniform step frequency of:

$$Δ f = \frac{{f}_{M} - {f}_{1}}{M - 1}$$

where M is the number of discrete frequencies in the set. The fundamental frequency will be referred to as fₒ and the harmonics as n fₒ where n is an integer such that 2fₒ, 3fₒ and 4fₒ refer to the second, third and fourth harmonic of fₒ respectively.

It is also necessary to define the radar field of view as the spatial volume that is approximately within the radar antennas radiation beam. The radar has antennas that transmit at one or two polarizations and that receive on one or two polarizations. The radar antenna may be a single antenna if the transmit and receive functions are accomplished with a common antenna. Alternatively, the radar antenna may also include up to four antennas—one for each transmitted polarization and one for each received polarization. Other combinations will be apparent to those of ordinary skill. Regardless of the ultimate design, the antennas are all assumed to be pointed in the same direction with a common field of view (FOV). When antenna polarization is considered in the following description, H and V will primarily denote horizontal and vertical polarization respectively. It will be apparent that other polarizations may also be used, such as RHC (right hand circular) and LHC (left hand circular) polarizations. Furthermore, it will be understood that the polarizations need only an approximate orthogonal component to be effective. For simplicity, the description will denote the polarizations as H and V with the understanding that the device and method may be implemented using any suitable combination of polarizations. In the preferred embodiment discussed below, the device has H and V for transmit and be sensitive to H and V on receive, resulting in four possible measurements denoted as HH, HV, VH and VV.

As the IED is suspected in the radars FOV, the radar samples signals from the M frequency steps. The radar receiver is sensitive to fₒ, 2fₒ, 3fₒ, etc. The radar can measure the various combinations of HH, HV, VH and VV polarizations. Hence there are 4M measurements for each of the fₒ and nfₒ harmonics. This data is stored and processed.

The samples corresponding to fₒ, are processed to determine the presence of the CDW and the nfₒ samples are processed to determine the presence of the NLJ. If a positive identification can be made then the IED target is declared. If the measurements are inconclusive then more data is collected by spatially moving the antenna by a few centimetres and repeating the data collection.

At each new spatial location, the new collected data is combined with the data collected at the previous location. This movement is part of the normal progression of the IED motion as a normal operation is to move forward down a road or path looking for IEDs. Sensors in the radar measure the spatial translation and orientation changes of the radar antenna such that over K spatial positions all of the data is built up. The variable K is settable by the user. A possible event could be that there is no positive IED detection for each of the individual samples at each spatial location however collectively over K observation positions, the feeble IED echo will be detectable above the background noise and interference (e.g., spatial beam forming). At this point where the ‘detection crosses a threshold level’ an alarm is raised and the user takes appropriate action such as destroying the IED.

All the data collected will be stored and after many spatial sample sets, a two dimensional surface scatter plot is generated from all of the data. The scatter plot image is subjected to artificial intelligence (AI) processing to detect the location of the CDW if it exists. The principle here is that the wire echo is spatially correlated, implying that it is a connected line that is detectable by the trained user or AI based on the whole scatterplot image that would not be detectable from consideration of a view of a small area containing only a small segment of the CDW.

If positive confirmation of the presence of the CDW or NLJ is made based on the radar observations, then it is necessary to determine the approximate location. This can be done by several methods. The radar antenna could be swept in azimuth picking up a stronger IED echo in a particular azimuth direction. At least then the azimuth direction is approximately known. Secondly, the Fourier beamforming is possible as the radar is swept over a frequency range. This provides a measure of the approximate range to the IED. Thirdly, the scatterplot collected after many spatial sets of data are combined can be used to locate the distributed CDW. Based on the approximate location of the CDW, it can in principle be found and cut at a ‘safe distance’ from the suspected IED position.

If the detonator is wireless and detected by the NLJ characteristic a further analysis can be done by characterizing the response of all the nfₒ samples over the frequency range and over the detectable set of harmonics where n=1,2,3, . . . and fₒ is the fundamental transmit frequency. Generally 2fₒ and 3fₒ are all that is available as higher harmonics are too weak. The overall set of samples generates a frequency characteristic that can be compared with known frequency signatures of commonly used wireless receivers. These could be brand name cell phones. A failure to correlate the NLJ frequency/harmonic characteristic with known receivers or conjectured generic varieties is an indication that the NLJ does not correspond to a wireless receiver but rather a buried metallurgical junction of some sort (e.g. rusty bolt) that should be construed as a false identification.

In certain embodiments, the device may coarsely scan a subset of the n frequencies and use the coarse scan to narrow a more fine scanning to more closely approximate the frequency that generates the largest NLJ response.

With positive NLJ identification, the objective is to permanently disable the wireless receiver. This may be done by first noting the frequency of the discrete set transmitted that generates the largest NLJ response in the harmonics. Then the transmitter is set to that frequency and the power significantly increased. The concept is to inject a sufficiently large amount of RF power into the front end of the IED wireless receiver that it will destroy the sensitive electronic components.

After the transmission of the pulse is completed, the radar is used to again sample the NLJ return levels. If there is a notable absence of the NLJ return then this provides confirmation that the IED wireless receiver has been disabled.

After each positive IED detection that resulted in subsequent examination of the device itself, whether an actual IED, decoy or metallurgical junction of buried objects, there is an opportunity to add to the IED classification data base. This would include the frequency signatures of the nfₒ harmonics. Over time, an extensive and increasingly useful data base will emerge that will assist in classification of each potential IED encountered. There are obvious applications of artificial intelligence (AI) expert systems and neural networks for such database management and interrogation.

2. Base Components

There will now be described some of the base components that the present system uses.

Transmitter/receiver. The transmitter sends out a CW sinusoidal signal for each frequency of a predetermined set of discrete frequencies. The return signal is sampled and is used in some means of reducing the noise of the desired signal or narrowing the range ambiguity function.

Adaptive interference cancellation methods. An enabler for the receiver is the interference cancellation that is based on suppression of the transmitter leakage into receiver transmitter signal which consists of fₒ and the nfₒ harmonics. As well, there is a sizeable static component of the surface clutter component comprised of the scattering reflections from the fundamental and residual harmonic components contained in the transmit signal that needs to be removed from the received signal.

In general, cancellation methods are known in the art, and only a brief discussion will be given. They include methods of taking a sampling of the transmitted signal which is then scaled, delayed and phase shifted such that it cancels the component of the transmitter signal in the receiver. As the signal for the radar is a sinusoidal signal, the cancellation scheme simultaneously cancels the transmitter leakage signal and the constant component of the surface clutter in the radar antennas field of view (FOV). Some cancellation methods use either a combination of an attenuator and phase shifter or a quadrature modulator with a pair of attenuators and a combiner to achieve the appropriate complex scaling of the transmitter sample to achieve cancellation in the receiver path. Various means of controlling the complex scaling components are also known in the art, and will not be discussed further.

In the present device and method, the interference cancellation is based on a prior calibration which sets parameters in the receiver for optimum suppression of fₒ and nfₒ when there is no IED present in the antenna FOV. When operating, there is an adaptive nulling based on standard numerical methods which can be construed as a form of least mean square (LMS) adaptive control. The signal used for the suppression is a scaled and delayed replica of the transmitted signal for fₒ and harmonics thereof for nfₒ suppression. In certain embodiments, a controller may monitor an amplified version of the nulled signal to determine the extent to which the transmitted signal should be scaled an delayed. A difficulty is that the frequency range of fₒ has to be large for four reasons:

1. The wireless receiver operates over a relatively narrow bandwidth. Interrogation frequencies outside of this band will not generate sufficient nfₒ harmonic content for detection of the wireless receiver.

2. The bandwidth has to be sufficiently broad and sampled with sufficient resolution to build up a frequency signature of the nfₒ response that can be used for identification.

3. The bandwidth must be sufficiently broad such that range focussing becomes possible of sufficient resolution.

4. The CDW typically has strong resonances in frequency depending on the lengths of each segment. A signature of a wire scattered signal in frequency is therefore a sequence of resonating peaks approximately periodic in frequency. This is a strong indication of the presence of a wire based on a sufficiently broad frequency range sampled at adequate resolution.

Fourier beam forming based on step frequency radar measurements. These methods are also known in the art. The principle is to coherently combine the number of samples taken by the radar receiver for the set of set frequencies used. This provides sharpening of the ambiguity function in terms of range.

In the present device and method, beamforming is done in range and azimuth based on the coherent combining of the multitude of measurement samples taken over the set of M discrete frequencies and K spatial positions.

Synthetic Aperture Radar (SAR) beam forming. This is a method of sharpening the effective radar beam within its antenna FOV. This is based on coherent combining of multiple spatial samples of the radar. The resulting synthetic beam can be electronically steered to build up a high resolution scattering image of the ground surface return within the radars FOV.

Nonlinear junction detection based on harmonic of the fundamental. With the detection of the NLJ based on using harmonics of the transmitted signal, it is well known that the electronic components in the wireless receiver contain electronic devices that behave in a mildly nonlinear fashion. Hence subjecting the receiver to a moderately large radio frequency signal within the band of the receiver will generate harmonics that are re-radiated.

In addition to the above components, the present system and method has the following characteristics:

1. a CW tone at fₒ is radiated and received;

2. active adaptive interference suppression is applied simultaneously to all of the nfₒ harmonics detected. This cancels out the harmonic interference that originates from the radar transmitter itself as the transmitted signal is not free of harmonic distortion;

3. The use of a frequency characteristic of the harmonics as the radar transmits a set of discrete frequencies across a broad band. The broadband sweep has two purposes. The first is to increase the probability that some of the radar tone transmissions fall within the IED receivers front end bandwidth. The second is that the density of frequency samples is sufficient to build up a frequency profile such that the IED receiver front end can be characterised. Of particular interest is if the characteristic can be shown to correlate with the harmonic frequency characteristic of an existing commercial wireless phone front end.

Using these components, the present system can be used to provide the following benefits:

1. Detection of feeble CDW echoes in the presence of radar clutter.

2. Resolvability of a likely CDW from other metallic clutter buried in the ground such as bolts, nails, odd pieces of metal and so fourth

3. Ability to image the CDW such that an operator or other artificial intelligence (AI) can be used to provide a reliable detection of the CDW.

4. Ability to image the CDW such that an operator or other artificial intelligence (AI) can be used to physically locate the distributed CDW.

5. Sensitivity for the detection of the nfₒ harmonics resulting in a very short practical operating range (e.g., a sensitivity of greater than 90 dB, a sensitivity of about 90-100 dB, 100-120 dB, 110-130 dB, 130-150 dB, 145-155 dB, about 140 dB, about 145 dB, about 150 dB, about 155 dB).

6. Database characterization of NLJ based wireless receivers across the nfₒ samples such that the IED receiver front end can possibly be identified.

Leakage suppression. In order to improve the accuracy of the radar, the transmit signal must be suppressed before getting into the receiver. The simplest way is to use separate antennas for transmit and receive functions, however there will still be a notable leakage component between the antennas. Hence, an actively controlled cancellation is preferably implemented. This may be achieved by various means, such as a phase shifter+attenuator, quadrature modulator, delay line with multiple taps, etc. However, the essence is always the same. The transmit signal is sampled, the sample is multiplied by a complex scaling factor and then added to the receiver path so that it is 180 degrees out of phase with the undesired leakage component.

In a preferred embodiment, the leakage suppression circuit consists of using a passive attenuator consisting of an arrangement of PIN diodes in series with a varactor based phase shifter. Note it is preferable to use the attenuator first as it minimizes the harmonic generation of the phase shifter. The analog drive voltages used to control the attenuator and phase shifter are obtained from a current buffered digital to analog convertor (DAC). The DAC is in turn controlled from the digital processor controlling the nulling. The output of the phase shifter is coupled into the receive signal arm with a directional coupler.

As mentioned above, separate antennas may be used, however this design is not always desirable for the radar as it increases the physical size. Hence, a single antenna is the preferred implementation. As the antenna has a single port, a circulator device is used to separate the transmit from the receive path. A narrowband circulator can achieve, for example, 30 dB of isolation which is generally insufficient for the desired sensitivity. A wideband circulator that would be required to obtain sufficient bandwidth relative to the swept frequency band would have poor isolation to the point that it is of limited use in separating the transmit from the receive path and providing impedance matching for the ports. It is possible to have a tuneable circulator by varying the magnetic field applied to the device. YIG tuned devices would have a considerable frequency range but these are bulky, expensive and limited in power handing capability. In any of these embodiments, active suppression would still be required.

Another option is to use a buffer amplifier at the antenna which is coupled directly to the antenna. The output of the buffer amplifier is coupled into a summer which is connected to a complex scaled version of the transmit signal for actively controlled cancellation. The isolation into the receiver is entirely achieved by the summer circuit. There is no isolation possible with the antenna/buffer amplifier. If the isolation buffer is very low and the complex scaling precise then this circuit will work well.

In certain embodiments, the digital processor may monitor an amplified version of the signal resulting from the summer to determine the extent to which the transmitted signal should be scaled an delayed.

To achieve the broad frequency range, modest initial isolation of the transmitter and receiver paths as well as power handling and a single antenna implementation it is necessary to have a special equivalent of the directional coupler.

Simultaneous detection. As described earlier, the radar preferably operates in two distinct but simultaneous modes which are: 1) processing of the fundamental, fₒ, for the detection of the command wire, and 2) processing of the harmonics 2fₒ, 3fₒ, etc. for the detection of the NLJ. As a single radar system can be sensitive to both the fundamental and the harmonic components, this provides a unified approach to detecting an unknown IED. Any RF electronics will potentially generate a harmonic signal of a characteristic indicative of a wireless receiver. Any command wire from the IED will echo back a fundamental. A typical IED will fall into one of these two categories. There may also be a sophisticated IED that uses a fiber optic link instead of a command wire. The fiber optic link is virtually undetectable, however such devices are very uncommon.

While it will be understood that the two modes (CDW detection and NLJ detection) of the radar operate simultaneously, they will be described below separately for clarity and convenience.

3. Wire Detector Radar (IEDWD)

The challenge of detecting the CDW is that the wire is buried in soil and therefore has a very small radar cross section (RCS) per unit length relative to the RCS of the surface clutter. Hence the IED wire detector (IEDWD) must have high sensitivity as well as signal processing to extract the feeble wire echo from the surface clutter echo. As the echo from the wire is very faint and competes with the much larger ground clutter return self interference, cancellation and signal processing methods are generally necessary. The interference cancellation is based on suppression of the transmitter leakage into receiver transmitter signals as well as the static component of the surface clutter component based on a scaled and delayed replica of the transmitted signal. The variable component of the surface clutter may be suppressed using synthetic beamforming methods.

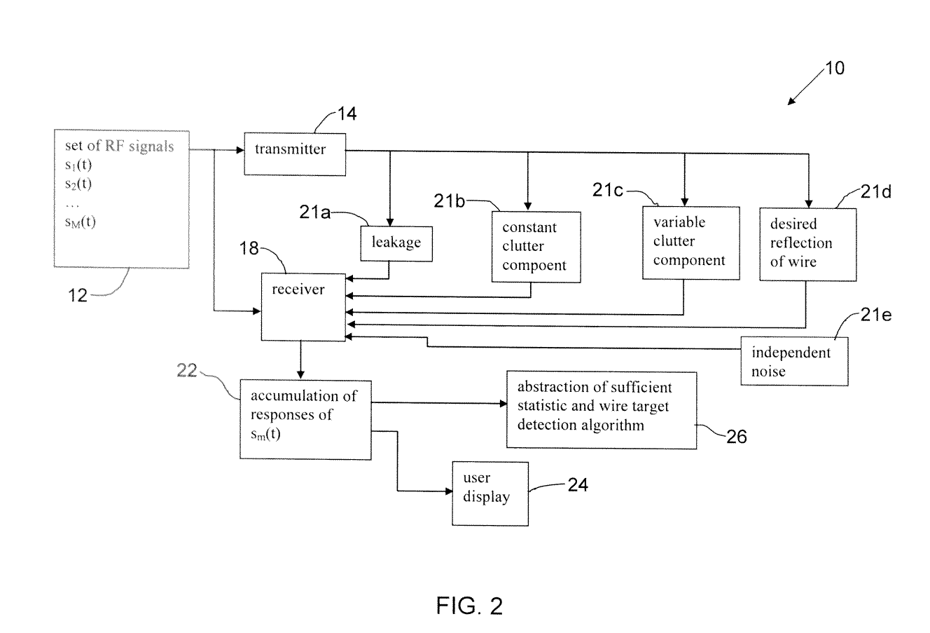

The block diagram of the IEDWD is shown in FIG. 2, and is identified generally by reference numeral 10. There is a generator 12 for a discrete set of candidate radio frequency (RF) stimulus signals that can be radiated by the transmitter 14 that has a radiating antenna. A receiver 18 with a receiving antenna receives the signal returns, including leakage 21a, constant clutter 21b, variable clutter 21c, and the reflection from a wire 21d, in addition to the independent noise component 21e that is independent of the signals generated by generator 12. An accumulator block 22 accumulates the responses for each of the stimulus signals. A user display 24 may be included that presents these responses in a fashion that is optimum for the user in terms of detection of the wire. A processing block 26 is programmed to abstract the sufficient statistic of the received responses for an automated wire detection algorithm.

As discussed earlier, a preferred implementation of the stimulus signal is a short burst of a sinusoidal signal at an RF frequency. Since the duration of the burst is much longer than the round trip return time of the radar, it is considered herein as CW (continuous wave). Hence, the set of stimulus signals is a set of relatively short RF bursts at M discrete frequencies. In one example,fi would be about 250 MHz and f₂ is about 500 MHz, with M being typically in the range of 50 to several hundred (e.g., greater than 5, greater than 10, greater than 15, greater than 20, greater than 25, greater than 30, greater than 35, greater than 40, greater than 45, greater than 50, greater than 60, greater than 70, greater than 80, greater than 90, greater than 100, greater than 125, greater than 150, greater than 200, greater than 250, greater than 300, greater than 400, greater than 500).

As shown in FIG. 2, there are generally four types of signal returns in addition to the independent additive noise 21e. The signal returns are described as:

a) Leakage component 21a—fraction of the transmitted signal that is coupled directly into the receiver 18 due to the non-ideal character of the transmit and receiver antenna and RF circuitry. It is assumed that this component is time invariant for each of the M stimulus signals.

b) Static clutter component 21b—in the FOV of the transmit and receive antenna there will be sources of clutter that reflect the signal. These give a constant deterministic return to the receiver.

c) Variable clutter component 21c—This is the component of the clutter in the antenna FOV that is random and therefore unpredictable. It changes with position of the antenna. It is essentially a consequence of the ground surface roughness, random inhomogeneous dielectric of the ground and sporadic source of reflection in the ground such as buried bolts, cans, short pieces of metallic pipe etc.

d) Wire reflection 21d—this is the only desired component of the four reflected signals. If the reflection of the wire is above a given threshold as determined by the receiver then the presence of the wire target is declared either by the wire detection algorithm or by the user via the user display.

It will be understood that the clutter components 21b and 21c are not only reflections of the fundamental frequency. While the transmitted signal is preferably made up of pure tones at a fundamental frequency, a small remnant of the second and third harmonics will likely be transmitted as well. These radiated second and third order harmonic components will be reflected off of the scattering objects in the FOV, and add to the static and variable clutter component that can obscure the faint harmonic signals emanating from a NJL target if not removed.

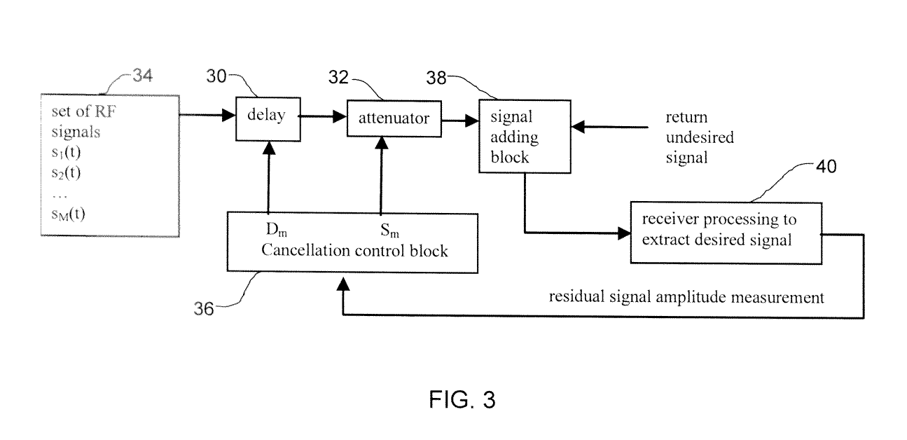

An aspect of the radar is the processing to remove the undesired signals returns such that the wire reflection can be isolated. The radar is first operated such that the FOV contains only a set of the undesired signals. For each of the individual stimulus signals (which may be generated using a rubidium oscillator and a phase lock loop, for example), the receiver adaptively nulls them out. This is preferably done using delay and attenuator circuits 30 and 32 as shown in FIG. 3. For each of the stimulus signals sₘ(t) from transmitter block 34, the parameters Dₘ (delay) and Sₘ (scale) are adaptively set by a cancellation control block 36 such that the signal output of the adding block 38 is nulled. Under this calibration approach, the complete set of calibration parameters of Dₘ and Sₘ, derived for the M stimulus signals is stored in a look-up table (LUT) and subsequently used when the radar is used to actually distinguish the wire return.

In certain embodiments, the configuration of the rubidium oscillator and the phase lock loop may produce signals for transmission with a bandwidth of less than 20 Hz, (e.g., less than 18 Hz, 15 Hz, 12 Hz, 10 Hz, 7 Hz, or 5 Hz, etc.) centered at the tone frequency of the transmitted signal.

The output of the sum block 38 would ideally contain only the desired signal and the additive noise. This output is directed to the receiver processing block 40 to extract the desired signal component (scattered signal from wire) from the additive noise. The receiver processing block 40 has the facility of measurement of the residual signal amplitude that is passed back to the adaptive nulling loop to control the delay and attenuator elements 30 and 32 by cancellation control block 36.

If the variable clutter component is negligible relative to the wire return then only a single stimulus signal is required. The noise is overcome by making the stimulus signal of longer duration such that it contains more signal energy. In this case the calibration effectively nulls the undesired signal return leaving only the desired wire signal. A wire detection scheme based on a simple threshold is therefore possible.

If there is not a constant clutter component then the calibration is based on nulling the leakage signal component only. The calibration then involves aiming the antenna FOV at a clear section of sky void of significant scattering objects.

Typically, the variable clutter component is not negligible and after the nulling of the static leakage and constant clutter terms, this variable clutter can mask the feeble return from the wire rendering it undetectable. In this case, multiple stimulus signals are used based on the assumption that the variable clutter will be independently random for each of the M stimulus signals while the corresponding responses for the desired wire signal are correlated. Hence, the receiver processing 40 in FIG. 3 will extract the M correlated responses of the wire echo from the independently random variable clutter components.

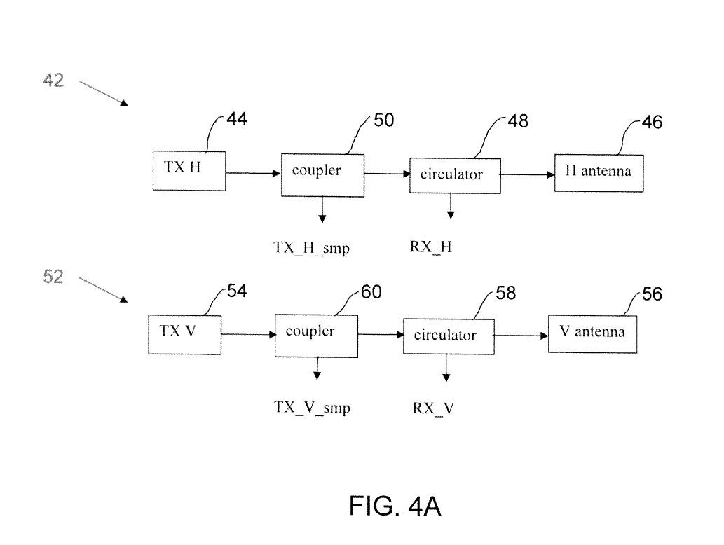

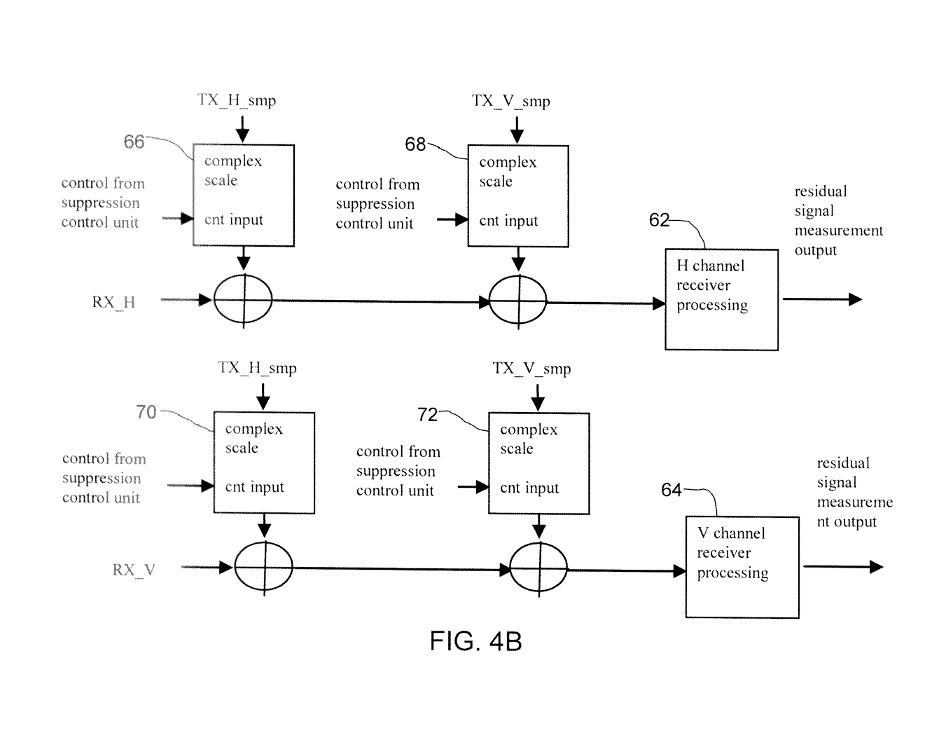

As described earlier, the radar will typically use a pair of different polarizations and hence two antenna feeds are necessary. The circuit is shown in FIGS. 4a and 4b. As leakage from both the H and V channels can penetrate each receiver it is necessary to cancel both of them separately. Hence, four complex scaling circuits are necessary, as shown in FIGS. 4a and 4b. These are all controlled from the cancellation control block with inputs from the receiver outputs of the H and V channels. The algorithm that determines the appropriate cancellation control voltages may be based on an LMS method, dithering method, or other suitable method. It is also assumed that there will be a lookup table (LUT) of the control voltages to the complex scaling blocks for each of the M frequencies.

Isolating the desired wire return from the variable clutter is the most difficult problem for any radar attempting to detect a buried wire at a distance. The M different stimulus signals used in the radar are chosen to be an orthogonal set of signals such that the resulting processing gain will be proportional to M. This may be insufficient when the wire return is particularly feeble relative to the variable clutter. The set of stimulus signals is limited as they have to be mutually orthogonal and that there is a limit in the range of suitable excitation frequencies. Low frequencies have better penetration but result in large unwieldy antennas that are not suitable for the portable radar. High frequencies have better spatial resolution but also have significant ground penetration losses. Hence M is limited by these constraints. To increase the number of stimulus signals (such that the desired wire signal return can be separated from the variable clutter) and provide more independent observations, there are two methods that may be implemented into the radar. These are based on polarization diversity and spatial diversity and are described as follows.

Polarization Diversity. As with any far field electromagnetic propagation, there are two orthogonal polarizations that can be used. Naturally horizontal (H) and vertical (V) variants of linear polarization can be used. In cases where the constant clutter term is large (smooth homogeneous ground surface) it is possible to exploit attributes of the two linear polarizations to isolate the wire return. Referring to FIGS. 4a and 4b, the radar can have two linear polarized antennas for transmission and reception that are oriented in the horizontal and vertical directions, where the H portion is indicated generally by reference numeral 42 and the V portion is indicated generally by reference numeral 52. It can also have the same set of orthogonally polarized antennas for transmit and receiver where the transmitter components in FIG. 4a and the receiver components in FIG. 4b are separated by a circulator 48/58, directional coupler 50/60 or other means of isolation. Referring to FIG. 4a, blocks 44 and 54 represent signal generators for the H and V components, respectively, which pass through the couplers 50/60 and the circulators 48/58 before being transmitted by the antennas 46 and 56. Referring to FIG. 4b, the received signals are received by the receiver antenna (not shown) for each polarization, and are combined with the signals from the couplers 50/60 and the circulators 48/58 before being processed by the respective channel receiver processing block 62 and 64. A control unit (not shown) is used to adjust the connection between the couplers 50/60 and the circulators 48/58 in blocks 66, 68, 70 and 72 to ensure the appropriate amount of signal cancellation.

It should be emphasized that although horizontal and vertical polarization is considered as the stated polarizations used, any two approximately orthogonal polarization antennas are suitable. Furthermore, it is not necessary to limit the transmission and reception to linear polarized antennas. For example a left and right hand circular polarized antenna set are applicable. In general, a pair of antennas for transmit and receive functions that are basically linearly independent are sufficient. Thus it will be understood that, while H and V are used in this discussion, these merely represent two orthogonal polarizations, or two polarizations with an orthogonal component. Regardless of the selection of the antenna polarizations, four measurements can be obtained for each of the M stimulus signals which are:

a) HH Receive H, transmit H

b) HV Receive H, transmit V

c) VH Receive V, transmit H

d) VV Receive V, transmit V

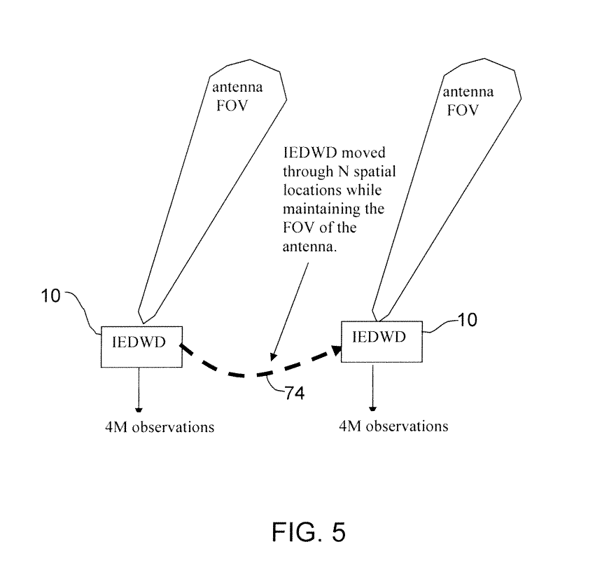

Spatial Diversity. Spatial diversity for the sake of increasing the number of independent observations such that the wire return can be separated from the variable clutter is based on physically translating the radar antenna while pointed in the same direction over N discrete locations. Referring to FIG. 5, a total of 4MN observations are possible with N antenna locations represented by line 74, and radar device 10 transmitting and receiving M excitation stimulus signals, and 2 polarizations on transmit and receive.

When multiple locations are used in the processing of the signals, the radar preferably incorporates methods of determining the relative displacement of the N spatial positions. This can be achieved by a variety of known methods based on GPS, inertial navigation, computer vision, vehicle wheel rotation counters and so fourth.

The set of stimulus signals comprising of M orthogonal stimulus signals, N discrete locations and 2 polarizations, can be combined to provide effective beam forming such that it is possible to map out where the wire return originated within the antenna's FOV. This can provide the user with a spatial scatter plot such that the geometric shape of the wire (which is typically approximately a segmented line) can be visually extracted from the variable clutter background. The WDR algorithm contains the processing to generate this spatial scatter plot.

Wire detector with swept frequency detection. A general limitation with the wire detector is that the clutter return comes from the relatively large region where the beam intercepts the ground surface. The resulting accumulation of ground clutter can be many times that of the radar cross section from the wire. It is necessary that the beam ground interception region is large in order that the search over the terrain can be accomplished with minimal operational time. Another reason the beam is large is that the operating frequency of the radar has to be relatively low for good ground penetration while at the same time maintaining the antenna to be of manageable size such that it is easily handled by an unaided human operator if necessary.

The present system provides a means of providing significant focusing of the beam through the use of coherent combining of radar samples taken at a set of M discrete frequencies. This is done by using beam forming techniques, such as Fourier beam forming, in the wire detection radar as a component of the surface clutter reduction.

An example of the Fourier beam forming is provided here. To keep the analysis simple, it is assumed that the antenna sends out a beam approximated by Gaussian pattern. This is not to suggest that the embodiment perceived is limited to the Gaussian beam antenna. It is more that it is an approximation of the average antenna beam that will be encountered in wire detection devices. It will be understood that, in the actual implementation of the system including the antenna characteristics, suitable calculations will be used based. In this example, the horizontal electric field is given by:

$${E}_{H} ( r , θ , φ ) = {E}_{o} \frac{1}{r} exp ( - {( \frac{θ}{{b}_{θ}} )}^{2} ) exp ( - {( \frac{φ}{{b}_{φ}} )}^{2} ) exp ( - j {rk}_{o} ) \qquad ( 1 )$$

where Eₒ is the electric field normalization constant, r is the range, θ is the elevation angle, φ is the azimuth angle, b_{θ} is the elevation half beam width, b_{θ} is the azimuth half beam width, and kₒ is the propagation constant of the IEDWD transmitted signal.

While these will vary with the antenna used, the present example is sufficient to demonstrate the effects of focusing. We are interested in the contour map of the ground pattern of the antenna of the operator holding the antenna at a 1 meter height and projecting forward with a tilt angle of γ. As we are interested in changes in the field focusing (1) can be simplified to a normalized pattern of:

$$E ( r , θ , φ ) = \frac{1}{r} exp ( - ( {θ}^{2} + {( φ - γ )}^{2} ) ) exp ( - j {rk}_{o} ) \qquad ( 2 )$$

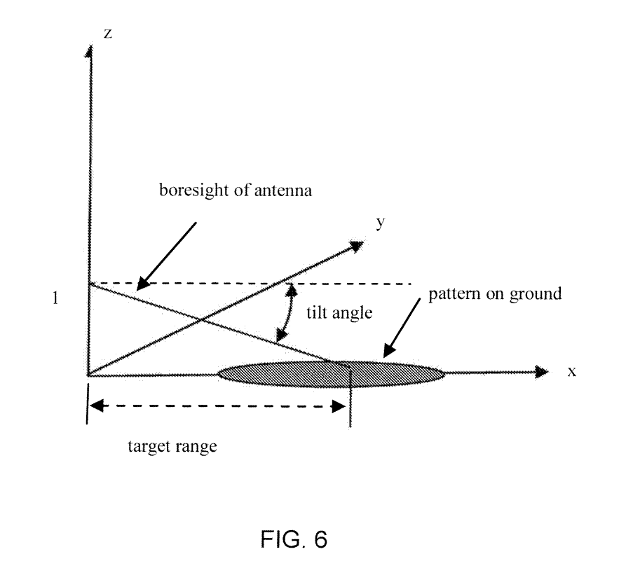

The vertical electric field will vary in a similar manner, however for the moment we are more interested in the power. Hence it will be assumed that θ and φ are normalized by respective beam widths. Referring to FIG. 6, with these definitions we can now generate the contour plot of the antenna on the surface of the ground that is being considered for the wire targets.

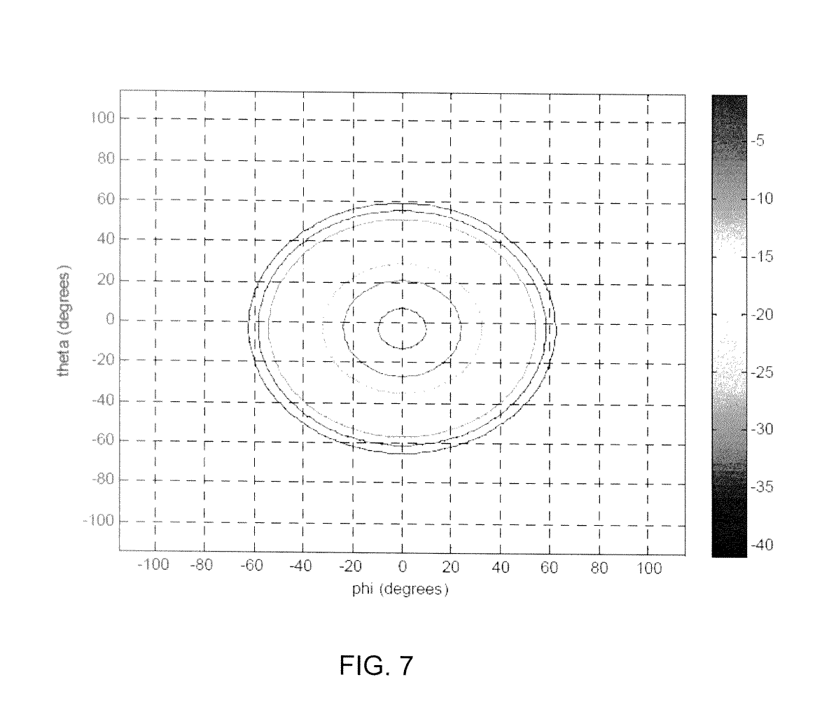

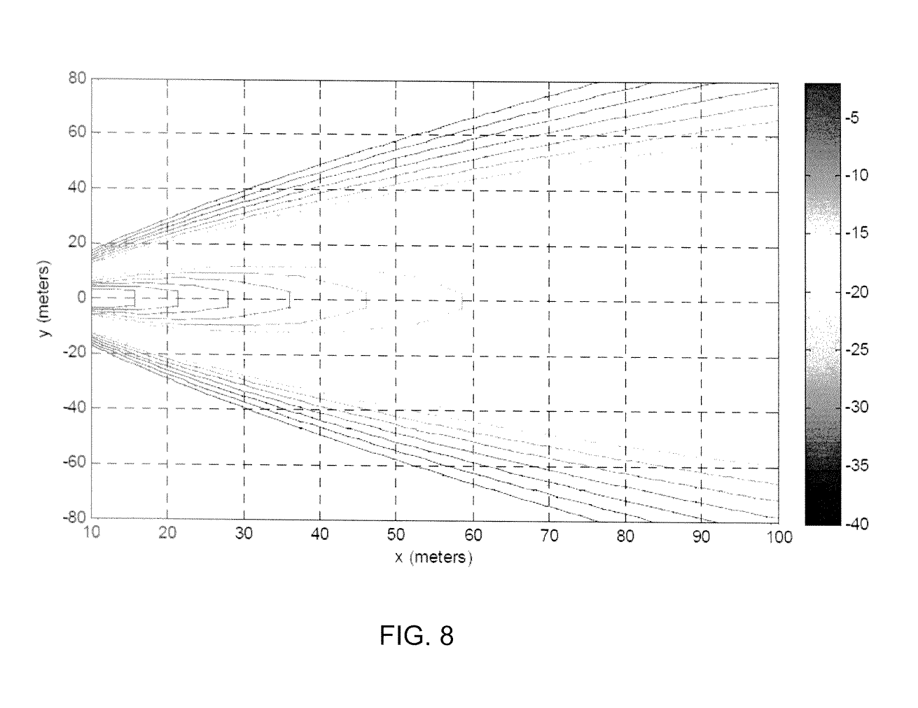

FIGS. 7 and 8 are contour plots of a radiation pattern of the assumed antenna normalized pattern with the following parameters: an azimuth half beamwidth of 0.5 radians, an elevation half beamwidth of 0.5 radians, a target range of 20 meters, and an antenna height of 1 meter. Note the negative tilt in elevation of the pattern.

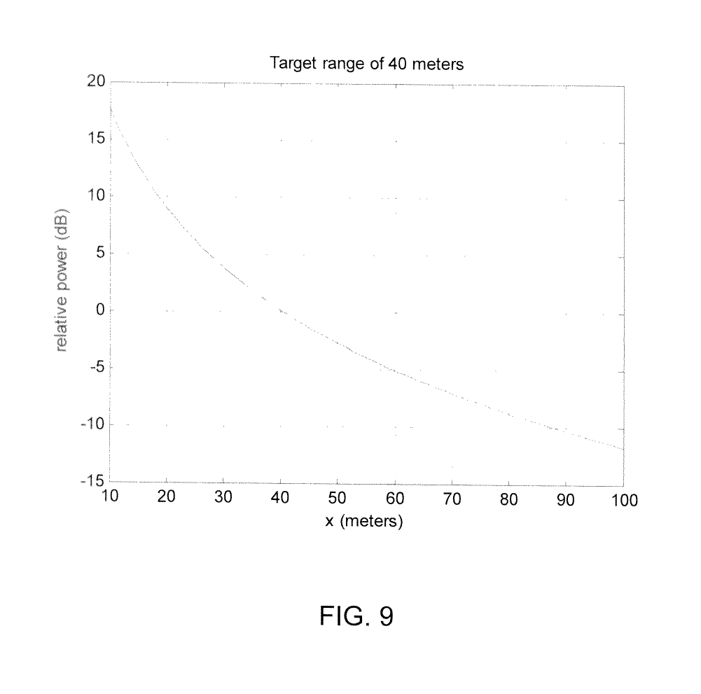

The simulated radiation beam, which is assumed to be the same for the transmit and receive directions, is now used to determine the clutter power that reaches the receiver as a function of range for various tilt angles. A typical plot is as given in FIG. 9. The plot is generated as the relative return power as a function of range. It is assumed that the radar cross-section of the ground surface clutter is uniform and independent of incident angle. The power is normalized with respect to the target range value. It should be noted that all of the power across the azimuth sweep is integrated.

As noted in FIG. 9, the close ranges contribute significantly. Clutter in the far range contributes also and the roll off of the contribution with increasing range is not overly steep. A reason for the gentle roll off is that the beam broadens with increasing range such that there is more clutter surface area at larger ranges.

If the ground surface is considered to be smoother, then the angle of incidence will be a factor. Typically this will result in a cos (θ_{inc}) type factor. For larger ranges θ_{inc} will be closer to 90 degrees which will result in cos (θ_{inc}) decreasing.

Next consider the swept frequency radar. Assume that there are N frequencies used uniformly sampled across the band of fₘᵢₙ to fₘₐₓ. Assume that the clutter return from a small area patch of surface is independent of frequency. We will revisit this assumption later. Now assume that we want to focus on the clutter signal at the specific target range. Suppose we want to focus at a particular target range of r_{T} then we have weights for the N samples given by

$${w}_{n} = exp ( j \frac{4 π {r}_{T} {f}_{n}}{c} ) \qquad ( 3 )$$

where c is the speed of light. Next we select Of to give an unambiguous range of 100 meters such that

$$Δ f = \frac{c}{2 {r}_{amb}} = \frac{3 {•10}^{8}}{2 •100} = 1.5 MHz \qquad ( 4 )$$

Note the factor of 2 is due to the range being traversed twice. Based on this

$$N = ⌈ \frac{{f}_{max} - {f}_{min}}{Δ f} + 1 ⌉ \qquad ( 5 )$$

Now consider the response from clutter at a given range of r based on the assumptions made. The power received after processing of the N samples will be proportional to

$$\begin{matrix}P ( r ) • {\vert {\sum }_{n = 0}^{N - 1} {w}_{n} {e}^{\frac{j4π {rf}_{n}}{c}} \vert}^{2} \\ where & ( 6 ) \\ {f}_{n} = {f}_{min} + n Δ f & ( 7 )\end{matrix}$$

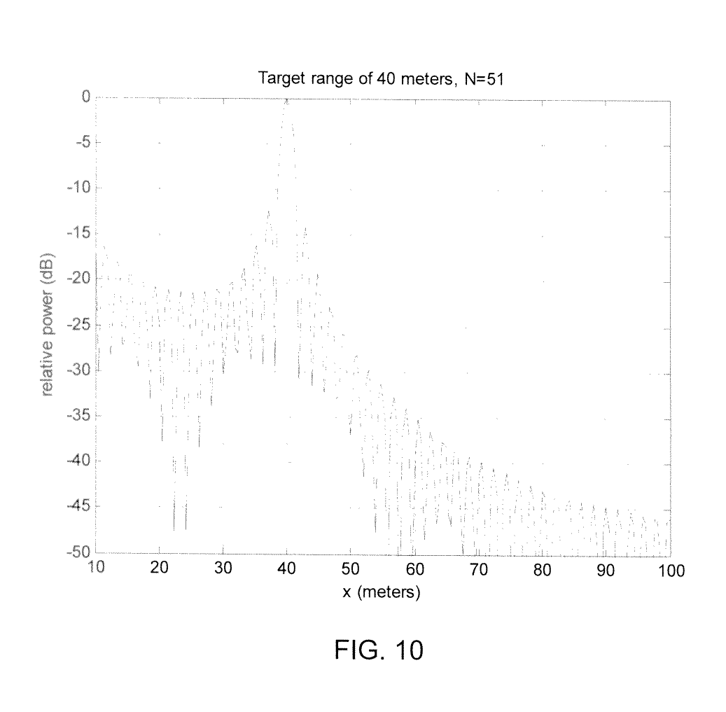

FIG. 10 shows a possible response for N=51, fₘₐₓ of 350 MHz and fₘᵢₙ of 250 MHz.

Synthetic array. The antenna can be spatially moved as the data is gathered which provides an additional two degrees of freedom for the further focusing of the beam. If the antenna trajectory is known relatively from a start position, then the beam forming algorithm can use this in the combining of the various samples to focus the beam. There are several means of estimating the trajectory which are all components of prior art, such as an inertial navigation unit or a GNSS (GPS) receiver co-mounted with the transceiver antenna.

4. NLJ Radar Mode

The NLJ radar may be considered a multiple channel version of the CDW radar described above. While the CDW radar uses only a receiver channel sensitive to fₒ, the NLJ radar has several receiver channels that are sensitive to its harmonics, namely, 2fₒ, 3fₒ, 4fₒ, etc. The primary objective of the NLJ receiver is to provide a very narrow band around nfₒ such that the background noise is essentially eliminated. The other objective is to suppress the nfₒ harmonics from the transmitter that leak into the nfₒ receiver channels. The transmitter portion attempts to reduce the harmonic distortion of the transmitted signal as much as possible by using a low distortion VCO followed by a tracking bandpass filter centered at fₒ. However, as the harmonic distortion is not zero, it is necessary to suppress it in the receiver channels. This is done by generating nfₒ harmonics of the transmit signal. These are scaled and delayed according to calibration parameters and added to the receive path. The block diagrams for the harmonics are similar to those depicted for the polarization components depicted in FIGS. 4a and 4b above, with an additional harmonic generator included.

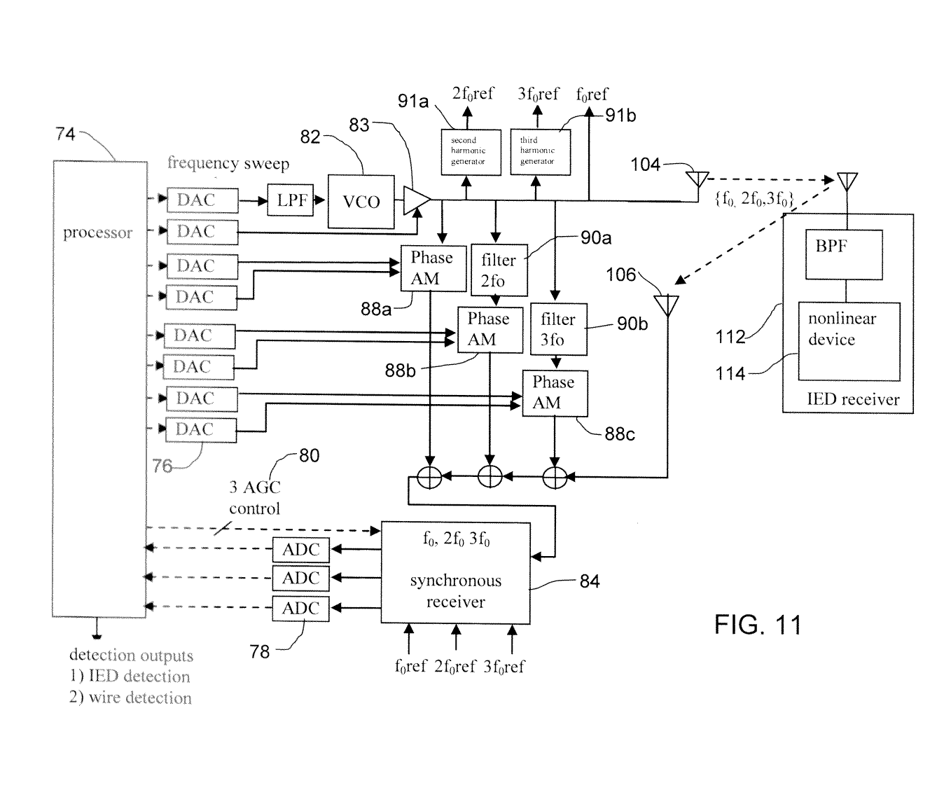

An example of an NLJ radar is shown in FIG. 11. In this particular example, the NLJ radar transmits over the band of 750 MHz to 1 GHz and has a receiver that is sensitive to the second and third harmonics which cover the ranges 1.5 GHz to 2 GHz and 2.25 GHz to 3 GHz respectively. The bands in this example are nonoverlapping, which simplifies the design requirements. However, other ranges of frequencies may be used that may overlap, in which case, tracking filters may be used to distinguish between the bands. It should be noted that the receiver is also sensitive to the fundamental component fₒ with cancellation achieved at the calibration step, hence the radar is suitable for wire scanning as well. In certain embodiments, the device may be sensitive to first and second polarizations at the fundamental component and a first harmonic. The band of 750 MHz to 1 GHz should produce some resonances of buried wired such that they can be identified. FIG. 11 shows a high level diagram of the NLJ radar which emphasises the DSP interface with a processor 74 in the form of DACs (digital to analog converters) 76, ADCs (analog to digital converters) 78 and AGC (analog gain control) blocks 80. The details of the microwave components such as the filters and directional couplers used are omitted for sake of simplicity. In the depicted embodiment, it is assumed that fₒ is a range of frequencies from 750 MHz to 1000 MHz, 2fₒ is a range from 1500 MHz to 2000 MHz, and 3fₒ is a range from 2250 MHz to 3000 MHz. Hence the labels ‘filter fₒ’ ‘filter 2fₒ’ and ‘filter 3fₒ’ imply passband filters over these respective ranges.

The digitized signals are defined as follows:

C_{VCO} Control voltage for VCO sweep tuning

C_{HPA} Control voltage for HPA output power

Cₚ₁ Control voltage for phase shifter for fₒ suppression loop

Cₐ₁ Control voltage for attenuator for fₒ suppression loop

Cₚ₂ Control voltage for phase shifter for 2fₒ suppression loop

Cₐ₂ Control voltage for attenuator for 2fₒ suppression loop

C^{p3} Control voltage for phase shifter for 3fₒ suppression loop

Cₐ₃ Control voltage for attenuator for 3fₒ suppression loop

Cₛ₁ Control voltage for scaling ADC of fₒ

Cₛ₂ Control voltage for scaling ADC of 2fₒ

Cₛ₃ Control voltage for scaling ADC of 3fₒ

A_{1I} I channel ADC output of fₒ synchronous detector

A_{1Q} Q channel ADC output of fₒ synchronous detector

A_{2I} I channel ADC output of 2fₒ synchronous detector

A_{2Q} Q channel ADC output of 2fₒ synchronous detector

A_{3I} I channel ADC output of 3fₒ synchronous detector

A_{3Q} Q channel ADC output of 3fₒ synchronous detector

C_{VCO} is a swept voltage that is generated digitally and is used to modulate the VCO frequency in block 82 in a triangle wave pattern. The slope of the wave is such that the nominal sweep rate of 1 MHz per 1 μsec is achieved. The lower and upper extremes of the frequency sweep will be 750 MHz and 1000 MHz respectively. The complete triangle modulation will have a period of 2 msec corresponding to a 500 Hz rate. The VCO output is amplified in the HPA 83 where the gain is controlled by //Cₕₚₐ. The output power of the HPA 83 will be nominally up to 10 W. The HPA output is connected to a circularly polarized antenna 104 which radiates to the IED device 112 consisting of a NLJ 114 which re-radiates the harmonics of fₒ back to the radar receiver arm. The receiver arm starts with a circularly polarized antenna 106 orthogonal to that of the transmitter. As shown the receiver arm consists of two suppression stages for the fₒ, 2fₒ and 3fₒ components that leak from the transmitter arm into the receiver arm as well as the synchronous receiver block. The first suppression stage 84 may be coupled directly into the received signal with the suppression signals originating with the naturally occurring harmonics in the generated signal after being appropriately filtered by filters 90 and conditioned by the phase/amplitude control blocks 88. The filters 90 and phase/amplitude control blocks 88 are controlled by the processor 74, communicating through the DACs 76, and based on outputs from the synchronous receiver 84 through the ADCs 78. The second suppression stage 86 may be coupled into the receiver block 84, with the signals being generated by harmonic generators 91, or obtained directly from the transmit signal in the case offₒ.

The suppression for the leakage components offₒ, 2fᵢ and 3fₒ is achieved by three feed-forward paths from the transmitter arm that use a phase/amplitude control block 88 and the appropriate filter 90. The fₒ feed-forward path samples the HPA output and modifies the phase and amplitude of this sample in block 88a by the control signals Cₚ₁ and Cₐ₁ respectively. The phase shifted and scaled sample is then fed into the receiver arm. The objective is to null the fₒ leakage component in the receiver arm by adjusting Cₚ₁ and C₁. To assist in this operation, the residual fₒ component is measured using a sampling sub-circuit made up of a filter centered at fₒ, a power detector and an ADC resulting in A₁ which is passed to the processor 74. A₁ is used by the processor 74 in a digitally implemented control loop which sets the values for Cₚ₁ and Cₐ₁. Typically this would be done with a calibration process prior to using the radar where the two antennas 104 and 106 are aimed into an absorbing space with no significant backscatter resulting in clutter.

In this embodiment a 2fᵢ and 3fᵢ pair of reference frequencies for the synchronous receiver are generated by the harmonic generator devices of 91a and 91b respectively. Simultaneously, the output of the transmitter power amplifier is filtered to select the harmonic components of 2fᵢ and 3fᵢ in 90a and 90b respectively. The filtered 2fₒ component is phase shifted and amplitude scaled in 88b and added to the receive path with the objective that this scaled and phase shifted 2fₒ component will cancel the leakage 2fₒ in the receive path. Likewise, the filtered 3fₒ component is phase shifted and amplitude scaled in 88c and added to the receive path with the objective that this scaled and phase shifted 3fₒ component will cancel the leakage 3fₒ in the receive path. The objective of nulling the 2fₒ leakage component in the receiver arm is achieved by adjusting Cₚ₂ and Cₐ₁ based on a feedback signal from a detector output. This detector output is determined by sampling the receiver signal after the addition of the feed-forward signal at 2fₒ. A filter in the 2fₒ band suppresses out of band noise. The 3fᵢ suppression circuit is similar.

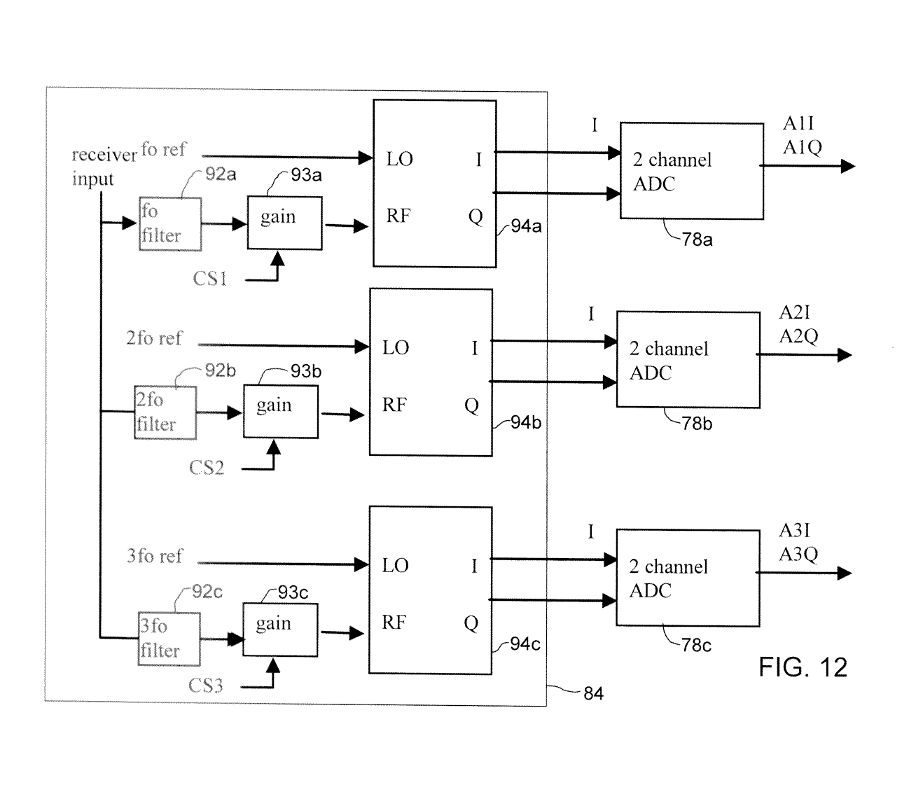

Once the signal emerges from the leakage signal suppression stages it enters the synchronous receiver. The block diagram of this subsystem is shown in FIG. 12. Here the signal is filtered by three bandpass filters 92a, 92b and 92c, equivalent to a triplexor configuration, and the strength is set by the gain stages 93a, 93b and 93c. The outputs of the bandpass filters are quadrature demodulated by blocks 94a, 94b and 94c and sampled based on 2 channel 10 bit ADCs 78a, 78b and 78c that are simultaneously sampled. To avoid dynamic range issues, there is a variable gain stage after the bandpass filter controllable by a signal from the FPGA. The f_{oref} signal used is obtained by directly sampling the transmit signal as shown in FIG. 11, while the 2f_{oref} signal and 3f_{oref} used are obtained by sampling the transmit signal through harmonic generators 91a and 91b.

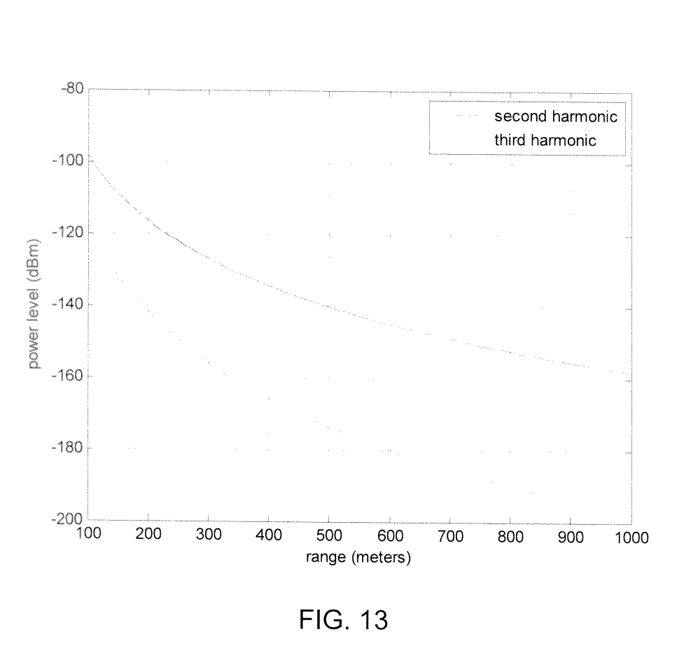

Based on the circuit for the NLJ radar in FIG. 11 and FIG. 12 and typical transmitter power of 10 watts, an antenna of gain of 10 dBi and typical conditions for the IED wireless handset receiver (based on a typical cell phone), the power level of the 2fₒ and 3fₒ harmonics can be approximately evaluated as shown in FIG. 13. As observed there is sufficient power in 2fₒ and 3fₒ components for a range of up to several hundred meters. Beyond that the power is too small to be of use for the NLJ detector. The low power level of the nfₒ return signals is an indication of the sensitivity the receiver must provide along with suppression of transmitter leakage components and background noise.

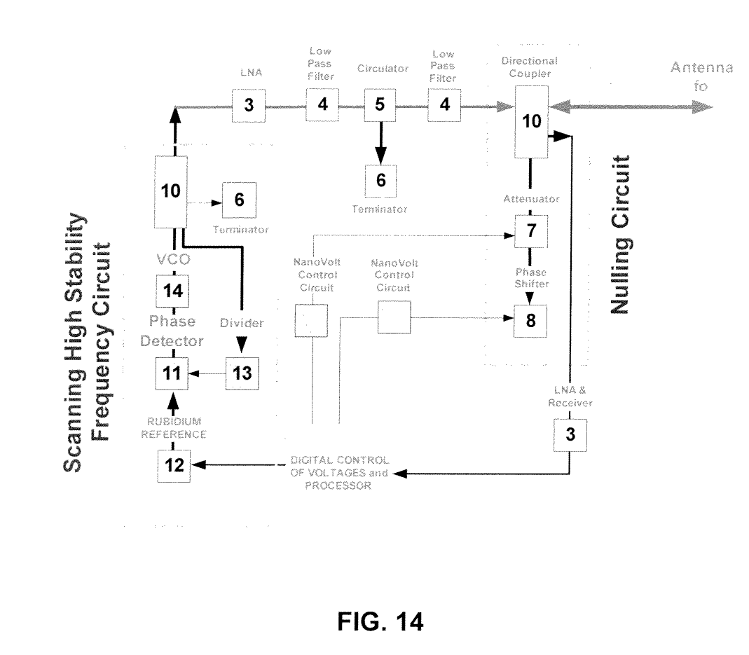

FIG. 14 is an exemplary embodiment of a stable frequency circuit in conjunction with a nulling circuit Although FIG. 14 illustrates an embodiment of a nulling circuit for the fundamental component, it should be understood that a similar circuit could be implemented for the detection of harmonic components as well. The scanning high stability frequency circuit includes a rubidium reference 12, a phase detector 11, a voltage controlled oscillator (VCO) 14, a directional coupler 10, and a frequency divider 13. The phase detector 11, VCO 14, and frequency divider 13 in the feedback path comprise a phase lock loop (PLL) for generating a stable frequency for the radar device. The phase detector 11 compares two input signals and outputs an error signal which is proportional to the phase difference of the two input signals. The error signal is then to drive a VCO which creates an output frequency. The output frequency is fed through an optional frequency divider back to the input of the system, producing a negative feedback loop. If the output frequency drifts, the error signal will increase, driving the VCO frequency in the opposite direction so as to reduce the error. Thus the output is locked to the frequency of the reference.

The frequency divider 13 can be in in the feedback path or in the reference path, or both, and it allows the PLL's output signal frequency to be a multiple of the reference input. In certain embodiments, the frequency divider 13 can be controlled by a processor to adjust the output frequency of the PLL. In this manner, the circuit can be configured to scan across multiple frequencies.

In general, the radar can be configured to transmit a set of M frequencies, such as in step sequence, where M is typically in the range of 50 to several hundred (e.g., greater than 5, greater than 10, greater than 15, greater than 20, greater than 25, greater than 30, greater than 35, greater than 40, greater than 45, greater than 50, greater than 60, greater than 70, greater than 80, greater than 90, greater than 100, greater than 125, greater than 150, greater than 200, greater than 250, greater than 300, greater than 400, greater than 500). Additionally, in certain embodiments, the configuration of the rubidium reference and the phase lock loop may produce signals for transmission with a bandwidth of less than 20 Hz, (e.g., less than 18 Hz, 15 Hz, 12 Hz, 10 Hz, 7 Hz, or 5 Hz, etc.)

The nulling circuit includes directional coupler 10, attenuator 7, and phase shifter 8. As discussed previously, the attenuator 7 and phase shifter 8 adjust the phase and amplitude of the transmitted signal so that it can be sufficiently nulled with the incoming signal.

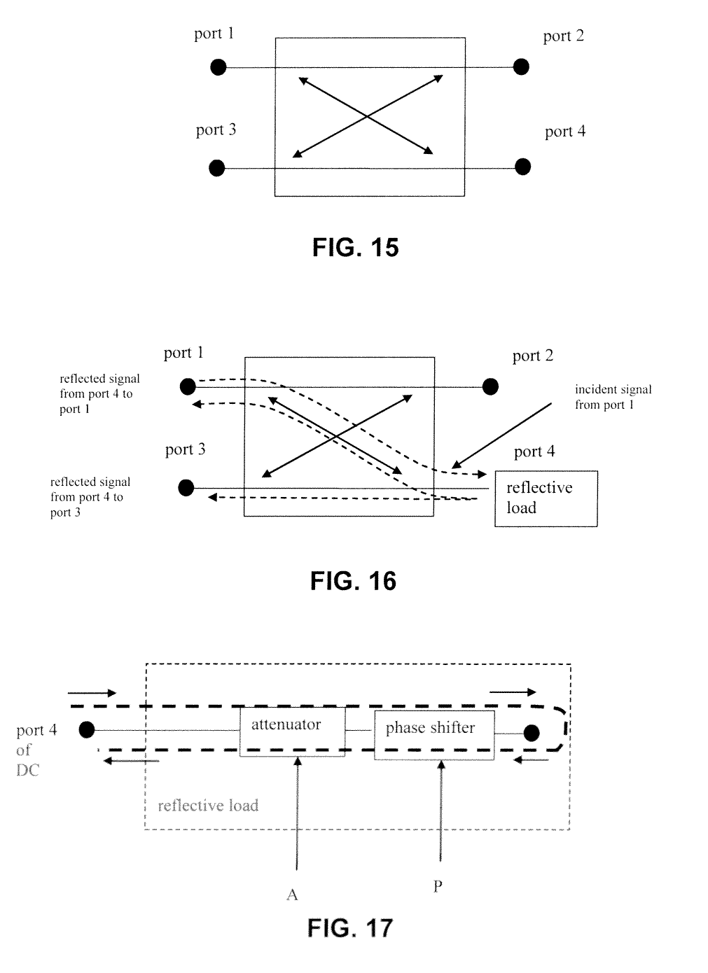

In certain embodiments, the directional coupler may be a four port RF device. A functional diagram of the coupler is illustrated in FIG. 15. Assuming an ideal, lossless device where the ports are terminated in matched loads, a signal input to port 1 will couple to port 4 with a power ratio of

$$r = \frac{output power in port 4}{input power in port 1}$$

where the signal power input into the other ports 2,3, and 4 is zero. A signal input to port 1 will couple to port 2 with a power ratio of

$$1 - r = \frac{output power in port 2}{input power in port 1}$$

where the signal power input into the other ports 2,3, and 4 is zero. Generally the device is symmetric such that a signal input to port 3 will couple to port 4 with a power ratio of

$$1 - r = \frac{output power in port 4}{input power in port 3}$$

where the signal power input into the other ports 1,2, and 4 is zero. A signal input to port 3 will couple to port 2 with a power ratio of

$$r = \frac{output power in port 2}{input power in port 3}$$

where the signal power input into the other ports 1,2, and 4 is zero.

If a reflective load is added to port 4 as shown in FIG. 16, the reflective load partially absorbs some of the signal from port 1 but reflects part of it back into port 4 of the directional coupler. This incident signal into port 4 couples into port 1 with a voltage ratio of \sqrt{r} and into port 3 with a voltage ratio of \sqrt{1−r}.

If the reflective load consists of a series attenuator and a phase shifter as shown in FIG. 17, the incident signal from port 4 of the directional coupler enters the reflective load and the following events take place as it follows the reflective path as illustrated in FIG. 17.

a) signal is attenuated by controllable attenuator with control parameter A

b) signal is phase shifted controllable phase shifter with control parameter P

c) output of phase shifter is an open circuit which reflects the signal back the other way

d) reflected signal gets phase shifted again in phase shifter by the same amount as in the forward direction

e) reflected signal gets attenuated again in attenuator by the same amount as in the forward direction

As observed, the reflected signal passes through the attenuator and phase shifter twice which provides twice the control range as compared to the signal only passing through in a single direction. As such, the output of port 3 of the directional coupler will be a scaled and phase shifted copy of the signal going into port 1 where the scaling and phase shift is controllable by setting A and P respectively.

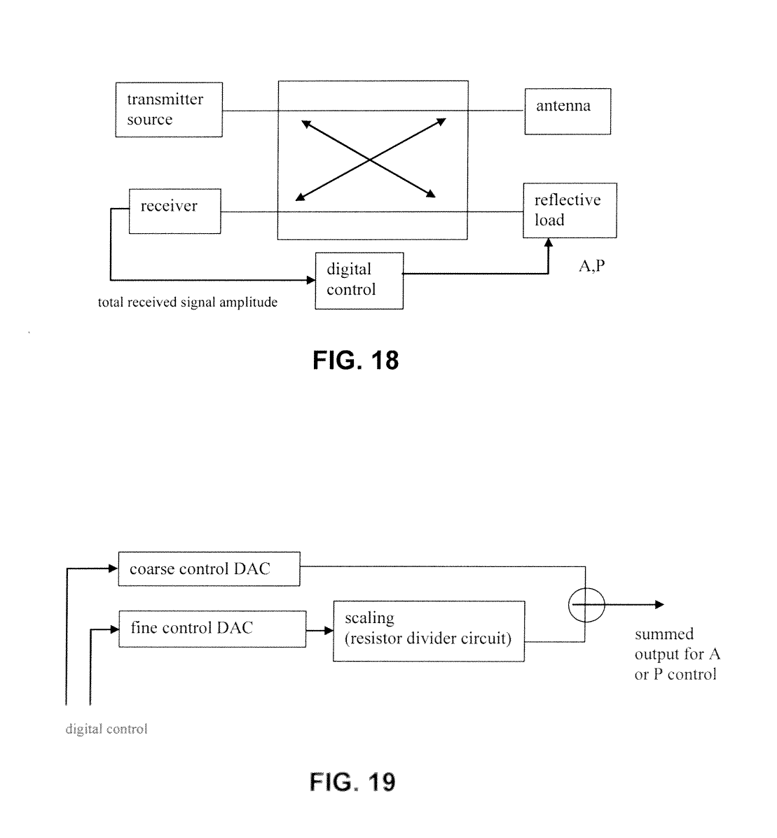

If the transmitter is connected to port 1 of the directional coupler and the antenna is connected to port 2 of the directional coupler as shown in FIG. 18, the transmitter signal is connected to the antenna via the directional coupler path from ports 1 to 2. The return echo from the target passes from the antenna to the receiver (ports 2 to 3 of the DC). In addition a portion of the transmitted signal passes from ports 1 to 4 of the DC is reflected by the reflective load back into port 4 which couples into the receiver port 3. The DC circuit is linear such that the two signal components into the receiver from the antenna and the reflective load are superimposed. By adjusting the A and P control inputs of the reflective load is it possible to adjust the phase and amplitude of the component from the reflective load coupled into the receiver to substantially cancel the signal component from the antenna. The receiver measures the amplitude of the superimposed sum of the two signal components and sends this information to the digital controller as shown. The digital controller dithers the controls A and P such that near exact cancellation of the antenna and reflected load signals are coupled into the receiver.

To reduce the risk of that the transmitter source attached to port 1 of the DC may reflect back some of the signal that passes from the antenna and from port 2 to port 1 of the directional coupler, an isolator may be used. In the embodiment in FIG. 14, this is implemented with a circulator 5 and matched terminator load 6.

In order to achieve substantial cancellation of the antenna return and reflective load signals in the receiver it is desirable to precisely control A and P. As the control of A and P is adaptive, the control does not have to be accurate in the absolute sense. However, it should be stable when the signal null is being approached. Also, A and P should be able to be smoothly controlled with, for example, nanovolt resolution. DAC's are not available to do this directly but they can be coupled together as shown in FIG. 19 to provide (in principle) the desired nanovolt resolution. However, the two stage control shown in FIG. 19 is not guaranteed to be monotonic which may be a requirement for realizing an efficient control of A and P.

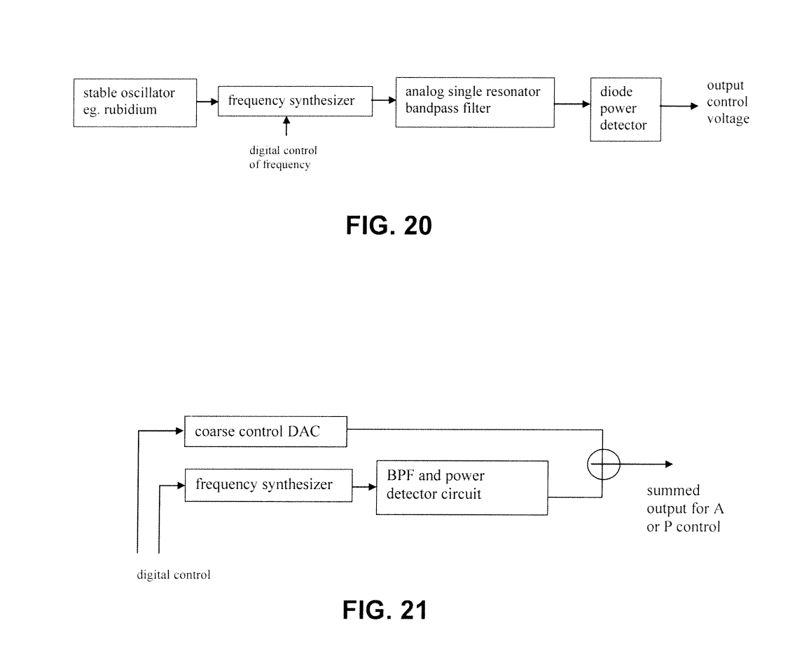

By replacing the fine control DAC in FIG. 19 with a filter-detector circuit, a highly stable output that is monotonic over a significant range can be achieved. As shown in FIG. 20, a stable oscillator that provides a reference frequency is translated to an arbitrary frequency based on a frequency synthesizer. The output of the synthesizer can be 10 to 50 MHz as in the present embodiment. This is fed into a low Q bandpass filter with a resonance frequency above 50 MHz (another option is to have the resonant frequency below 10 MHz). The output of the filter is coupled into a power detector. The detector may be based on a silicon crystal diode, but any semiconductor material could also be a bipolar transistor instead. The voltage output of the power detector is the desired control voltage with high stability and resolution. In certain embodiments, a low pass filter (not shown) may be used at the output of the power detector to suppress higher frequency noise generated by the detection process.

To give the nanovolt control source in FIG. 20 more range, a coarse control which can either be provided by an analog source or a DAC may be added, as shown in FIG. 21. When using this controller in setting the null the coarse control DAC is set first with the nanovolt source set to a midpoint value. Then the course DAC is fixed and the nanovolt controller is used to provide the fine control.

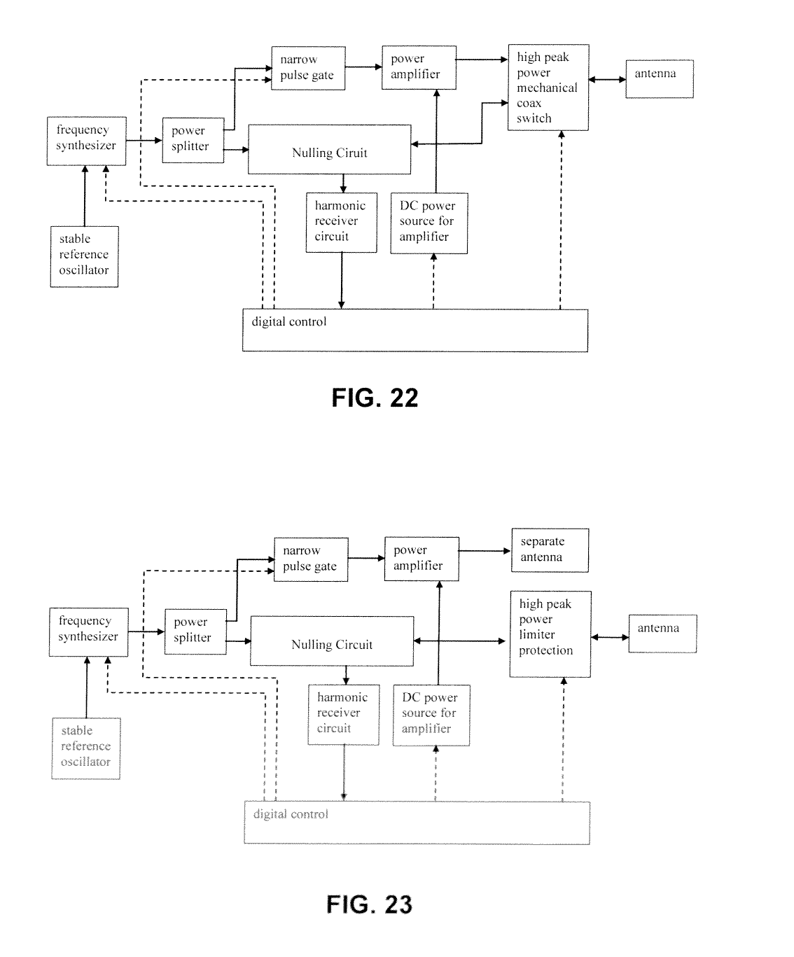

FIG. 22 is an exemplary embodiment of a destruction and/or disabling circuit used in conjunction with a nulling circuit, such as the nulling circuits described herein. In certain embodiments, the desctruction circuit may utilize a stable reference oscillator such as the rubidium or ovenized crystal oscillators described herein. The circuit may also include a frequency synthesizer (e.g., a phase lock loop) as described herein. The destruction and/or disabling circuit may also include a power splitter, a narrow pulse gate and a power amplifier (which may be driven by a DC power source). In the embodiment, of FIG. 22, the device includes a single antenna or at least shares an antenna with the low power sweeping circuit. Accordingly, a high power switch is provided. In the embodiment of FIG. 23, two antennas are provided.

In operation, the device may begin in a normal low power transmit sweep mode with, for example, a harmonic receiver such as those discussed herein, for detecting the presence of a non linear junction. Based on the frequency sweep data a resonance may be observed (i.e., over a small bandwidth of transmitted frequency sweep the observed harmonic levels become relatively larger). The maximum resonance frequency may be noted and the synthesizer could be set to that frequency. The antenna switch is switched over to couple the power amplifier output to the antenna. The DC power for the high power amplifier is turned on and a short and timed gated pulse is issued from the sweep frequency synthesizer output to the input port of the power amplifier. After the pulse is amplified, the DC power for the high power amplifier may be turned off and the antenna switch is switched back to the low power transmitter output. In certain embodiments, the frequency sweep may be performed as a coarse sweep followed by a fine sweep.

In certain embodiments, after the pulse is transmitted, a frequency sweep may be done over the range around the resonance response and the harmonic levels noted. These may be stored and compared to the previously stored harmonic level record (in certain embodiments, prior to transmitting the pulse, an additional sweep may be done to capture the harmonic levels in the vicinity of the resonance which are stored in memory). The difference may be noted and a decision made as to if the non linear junction has been destroyed and/or disabled. Ideally there would no longer be observable harmonics which would constitute a decision that the non linear junction had been satisfactorily destroyed and/or disabled. However, as the signals are weak and corrupted by noise, the comparison of the harmonic response with the prior harmonic response may be summarized in a likelihood value. The higher the likelihood value the higher the confidence that the NLJ has been destroyed.

In certain embodiments, when the device is in high power pulse mode the antenna switch may disconnect the components in the low power transmitter and receiver circuit to protect these components from the high signal levels of the high power amplifier.

As shown in FIG. 23, an optional embodiment is to have a separate antenna for the high power antenna output. This may be done for safely reasons.

As would be understood by a person of ordinary skill in the art, the duration of the pulse may be controlled by a power source where the turn-on and turn-off instances are controlled by a controller. In certain embodiments, the time duration of the high power pulse may be adjusted to compromise between getting enough energy out to destroy and/or disable the device and to save battery power. In certain embodiments, the digital controller may make this decision based on the strength of the harmonic resonant signals. (the stronger they are the less pulse time is required).

In certain embodiments, the system may have a database of all known types of non linear junctions which may be indexed by second or third harmonic frequencies, and for which the timing of the pulse is known from previous disabling attempts. In this manner, the device would know what pulse duration would be effective.

While the radar systems described herein are primarily continuous wave systems, other radar types can also be implemented. The may include impulse; pulse; Swept FM; and CW. Any of these types can be in either a co-polarization or cross polarization implementation. Additionally, the radar could by monostatic, bistatic, balance bridge; etc. Additionally, the antenna(s) may be of a single frequency band and polarization, or can be for example, multiple linear; multiple elliptical; multiple circular polarization; and these may include single or multiple frequency bands.

In this document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1. A radar device for detecting improvised explosive trigger devices, comprising:
a transmitter with frequency adjustability and power adjustability for transmitting electromagnetic signals with a first and second polarization,
a tuneable receiver for receiving a reflection of the electromagnetic signal transmitted by the transmitter and at least one harmonic frequency thereof;
an actively controlled cancellation circuit comprising a signal path between the transmitter and the receiver for each of the first polarization and the second polarization of the electromagnetic signal and the at least one harmonic frequency thereof, each signal path consisting essentially of:
i. a directional coupler; and
ii. a reflective load coupled to a terminal of the directional coupler; and
a processor configured to compare at least one output of the actively controlled cancellation circuit to at least one of a previously received output of the actively controlled cancellation circuit and/or a predetermined reference to identify the presence of a conductive wire and/or a non-linear junction within a field of view of the radar device.

2. The device of claim 1, wherein the reflective load comprises an attenuator and phase shifter controlled by the processor.

3. The device of claim 2, wherein the processor is configured to control the phase shifter and the attenuator by outputting a highly stable control signal that is substantially monotonic relative to a desired control input.

4. The device of claim 1, further comprising at least one of a visual indicator, graphical display, or scatterplot to indicate the presence of the command wire or the non-linear junction.

5. The device of claim 1, wherein the actively controlled cancellation circuit has a rejection level of greater than 50 dB (i.e., greater than 50 dB, 60 dB, 70 dB, 80 dB, 90 dB, 100 dB, 110 dB, 120 dB, 130 dB, 140 dB, 145 dB, 150 dB, 155 dB, 160 dB).

6. The device of claim 1, wherein the device is configured to sweep across at least one octave.

7. The device of claim 1, wherein the device is configured to sweep across at least 50 (i.e., at least 75, 100, 125, 150, 175, 200, 225, 250) frequencies.

8. The device of claim 1, further comprising:
a circuit capable of disabling non linear junctions; and
a processor capable of a coarse frequency scanning mode and a fine frequency scanning mode.

9-21. (canceled)

22. A method of using the device of claim 8, comprising:
scanning a target area in the coarse scanning mode until an indication that a non-linear junction is present is received at a first frequency;
scanning the target area in a fine scanning mode until an indication that a non-linear junction is present is received at a second frequency;
setting the transmitter to the second frequency transmitting a power pulse of a predetermined duration at a significantly increased level to destroy the identified device; and
confirming that the identified device has been destroyed by transmitting a signal at the second frequency and observing the that substantially no non linear junction response in the harmonics is generated.

23. A device comprising:
at least one transmitter with frequency adjustability and power adjustability configured to transmit an electromagnetic signal with a first and second polarization at a plurality of frequencies;
a command wire detection circuit configured to detect a command wire of an improvised explosive device, comprising:
a tuneable receiver comprising:
i. a first actively controlled cancellation circuit configured to receive the reflection of the electromagnetic signal with the first polarization; and
ii. a second actively controlled cancellation circuit configured to receive the reflection of the electromagnetic signal with the second polarization;
a non-linear junction detection circuit configured to detect a non-linear junction within the improvised explosive device, comprising:
a receiver comprising:
i. a third actively controlled cancellation circuit configured to receive the at least one harmonic of the electromagnetic signal; and
a processor configured to compare the at least one output of the command wire detection circuit and/or the non-linear junction detection circuit with a predetermined reference and/or with previously received electromagnetic signals to generate an indication based on the current and previously received electromagnetic signals that can be used to locate the command wire and/or non-linear junction;
wherein each actively controlled cancellation circuit comprises a reflective load;
wherein the actively controlled cancellation circuit has a rejection level of greater than 50 dB; and
wherein the adjustable transmitter is configured to sweep across at least 10 frequencies.

24. The device of claim 23, wherein the reflective load comprises an attenuator and phase shifter controlled by the processor.

25. The device of claim 24, wherein the processor is configured to control the phase shifter and the attenuator by outputting a highly stable control signal that is substantially monotonic relative to a desired control input.

26. The device of claim 23, wherein the device is configured to sweep across at least one octave,

27. The device of claim 23, wherein the device is configured to sweep across at least 50 (i.e., at least 75, 100, 125, 150, 175, 200, 225, 250) frequencies.

28. The device of claim 23, further comprising:
a circuit capable of disabling non linear junctions; and
a processor capable of a coarse frequency scanning mode and a fine frequency scanning mode.

29-41. (canceled)

42. A method of using the device of claim 28, comprising:
scanning a target area in the coarse scanning mode until an indication that a non-linear junction is present is received at a first frequency;
scanning the target area in a fine scanning mode until an indication that a non-linear junction is present is received at a second frequency;
setting the transmitter to the second frequency transmitting a power pulse of a predetermined duration at a significantly increased level to destroy the identified device; and
confirming that the identified device has been destroyed by transmitting a signal at the second frequency and observing the that substantially no non linear junction response in the harmonics is generated.

43-152. (canceled)

153. A method of detecting buried conductors, comprising the steps of:
transmitting a signal from a transmitter having a field of view, the transmit signal comprising an electromagnetic signal having signal components comprising first and second polarizations and multiple frequencies;
receiving a signal from the field of view by a receiver; and
detecting first and second polarization components and fundamental and harmonic frequencies corresponding to the first and second polarization components and multiple frequencies in the received signal;
comparing the received signal components to characterize the received signal and identify a remote device as a linear electrical component or a non-linear electrical component based on predetermined criteria; and
generating a notification signal when the remote device is identified.

154. The method of claim 153, wherein comparing the received signal components comprises forming a background image of the field of view from the received signal and identifying differences in the received signal relative to the background image.

155. The method of claim 153, wherein at least one of the transmitter and the receiver comprise a first antenna for the first polarization component and a second antenna for the second polarization component.

156. The method of claim 153, wherein at least one component of the transmit signal is transmitted, and at least one component of the received signal is received, by a single antenna.

157-168. (canceled)
